(19) United States
(12) Patent Application Publication
(10) Pub. No.: US 2025/0330243 A1
(43) Pub. Date: Oct. 23, 2025

(54) RYDBERG ATOM TELEVISION RECEIVER AND RECEIVING A MODULATED WAVEFORM IMPRINTED ON A RADIOFREQUENCY CARRIER

(71) Applicant: Government of the United States of America, as represented by the Secretary of Commerce, Gaithersburg, MD (US)

(72) Inventors: Nikunjkumar Rasikbhai Prajapati, Lafayette, CO (US); Matthew Thomas Simons, Lafayette, CO (US); Samuel Berweger, Boulder, CO (US); Andrew Peter Rotunno, Broomfield, CO (US); Alexandra Brae Artusio-Glimpse, Boulder, CO (US); Christopher Lee Holloway, Boulder, CO (US)

(21) Appl. No.: 19/121,076

(22) PCT Filed: Oct. 16, 2023
(86) PCT No.: PCT/US2023/035217

§ 371 Date: Apr. 14, 2025

Related U.S. Application Data
(60) Provisional application No. 63/416,265, filed on Oct. 14, 2022.

(51) Int. Cl. H04B 10/2575; H04B 10/50

(52) U.S. Cl. CPC H04B 10/25751; H04B 10/503

(57) ABSTRACT

A Rydberg atom television receiver is disclosed. The receiver comprises a probe laser, a source polarizing beam displacer, a Rydberg atom receiver cell, receiver atoms, a detector polarizing beam displacer, a detector polarizing beam cube, a first photodiode, a second photodiode, a differential amplifier, a display, and a coupling laser. The receiver receives a modulated waveform imprinted on a radiofrequency carrier a displays a graphical representation corresponding to a modulation source.

### CROSS REFERENCE TO RELATED APPLICATIONS

This application claims the benefit of U.S. Provisional Patent Application Ser. No. 63/416,265 (filed 14 Oct. 2022), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BRIEF DESCRIPTION

Disclosed is a Rydberg atom television receiver for receiving a modulated waveform imprinted on a radiofrequency carrier comprising a probe laser in optical communication with a Rydberg atom receiver cell that produces a probe laser light and communicates the probe laser light to the Rydberg atom receiver cell, a source polarizing beam displacer in optical communication with the probe laser and in optical communication with the Rydberg atom receiver cell that receives the probe laser light from the probe laser, optically splits the probe laser light, produces a signal arm laser light and a reference arm laser light from optically splitting the probe laser light, and communicates the signal arm laser light and the reference arm laser light to the Rydberg atom receiver cell, a Rydberg atom receiver cell in which is disposed receiver atoms and in optical communication with the probe laser and in optical communication with a coupling laser and in communication with an antenna that comprises receiver atoms disposed in the Rydberg atom receiver cell, receives the probe laser light and the coupling laser light in a signal arm laser light, receives the probe laser light in a reference arm laser light, receives a radio frequency field from the antenna, subjects the receiver atoms to the probe laser light along the reference arm laser light, subjects the receiver atoms to the probe laser light and the coupling laser light along the signal arm laser light, and subjects the receiver atoms to the radio frequency field along the signal arm laser light and the reference arm laser light, receiver atoms disposed in the Rydberg atom receiver cell and in optical communication with the probe laser and in optical communication with the coupling laser and in communication with the antenna that receive the probe laser light and the coupling laser light from the signal arm laser light, receive the probe laser light from the reference arm laser light, receive the radio frequency field from the antenna, transition between an electronic ground state and an intermediate electronic state in response to receiving the probe laser light, transition between a first Rydberg state and the intermediate electronic state in response to receiving the coupling laser light, and transition between the first Rydberg state and a second Rydberg state in response to receiving the radio frequency field, a detector polarizing beam displacer in optical communication with a detector dichroic and in optical communication with the Rydberg atom receiver cell that receives the probe laser light along the signal arm laser light and the reference arm laser light after the probe laser light communicates through the Rydberg atom receiver cell, combines and interferes the probe laser light from the signal arm laser light and the reference arm laser light, produces a Rydberg receiver optical signal from the combination and interference of the probe laser light in the signal arm laser light with the probe laser light in the reference arm laser light, and communicates the Rydberg receiver optical signal to a detector polarizing beam cube, a detector polarizing beam cube in optical communication with the detector polarizing beam displacer and in optical communication with a second photodiode for detecting the other output port of an element first photodiode and in optical communication with a first photodiode that receives the Rydberg receiver optical signal from the detector polarization controller, interferes components of the Rydberg receiver optical signal produced from the signal arm laser light and the reference arm laser light for homodyne detection, produces a first output light and communicates the first output light to the first photodiode, and produces a second output light and communicates the second output light to the second photodiode for detecting the other output port of the element, a first photodiode in optical communication with the detector polarizing beam cube and in electrical communication with a differential amplifier that receives the first output light from the detector polarizing beam cube, converts the first output light to a first output signal, and communicates the first output signal to the differential amplifier, a second photodiode for detecting the other output port of an element in optical communication with the detector polarizing beam cube and in electrical communication with a differential amplifier that receives the second output light from the detector polarizing beam cube, converts the second output light to a second output signal, and communicates the second output signal to the differential amplifier, a differential amplifier in electrical communication with the first photodiode and in electrical communication with the second photodiode for detecting the other output port of an element that receives the first output signal from the first photodiode, receives the second output signal from the second photodiode for detecting the other output port of the element, determines the difference between the first output signal and the second output signal, produces a differential signal from the difference between the first output signal and the differential signal for balanced homodyne detection, a display in electrical communication with an analog-to-digital converter that receives a receiver output signal from the analog-to-digital converter and displays a graphical representation of the receiver output signal, and a coupling laser in optical communication with the Rydberg atom receiver cell that produces a coupling laser light and communicates the coupling laser light to the Rydberg atom receiver cell.

Disclosed is a process for receiving a modulated waveform imprinted on a radiofrequency carrier with a Rydberg atom television receiver, the process comprising: providing a probe laser light to a Rydberg atom receiver cell; optically splitting the probe laser light into a signal arm laser light and a reference arm laser light; subjecting receiver atoms disposed in Rydberg atom receiver cell to the signal arm laser light and coupling laser light, such that the probe laser light transitions receiver atoms between electronic ground state and intermediate electronic state, and the coupling laser light transitions receiver atoms between intermediate electronic state and first Rydberg state; subjecting receiver atoms disposed in Rydberg atom receiver cell to the reference arm laser light in an absence of coupling laser light, such that the probe laser light transitions receiver atoms between electronic ground state and intermediate electronic state; subjecting receiver atoms disposed in Rydberg atom receiver cell to a radio frequency field, such that the receiver atoms transition between first Rydberg state and second Rydberg state in response to receiving the radio frequency field; combining and interfering the probe laser light from the signal arm laser light and the reference arm laser light; interfering components of the combined and interfered probe laser light produced from the signal arm laser light and the reference arm laser light for homodyne detection; converting the interfered components of the combined and interfered probe laser light into first output light and second output light; determining the difference between the first output light and second output light; producing a differential signal from the difference between the first output light and second output light; converting the differential signal into a receiver output signal; and displaying a graphical representation of the receiver output signal.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a Rydberg atom television receiver.

FIG. 2 shows, according to some embodiments, a modulated radiofrequency generator.

FIG. 3 shows, according to some embodiments, an atomic electronic energy level diagram for receiver atoms.

FIG. 4 shows, according to some embodiments, a process for receiving a modulated waveform imprinted on a radiofrequency carrier.

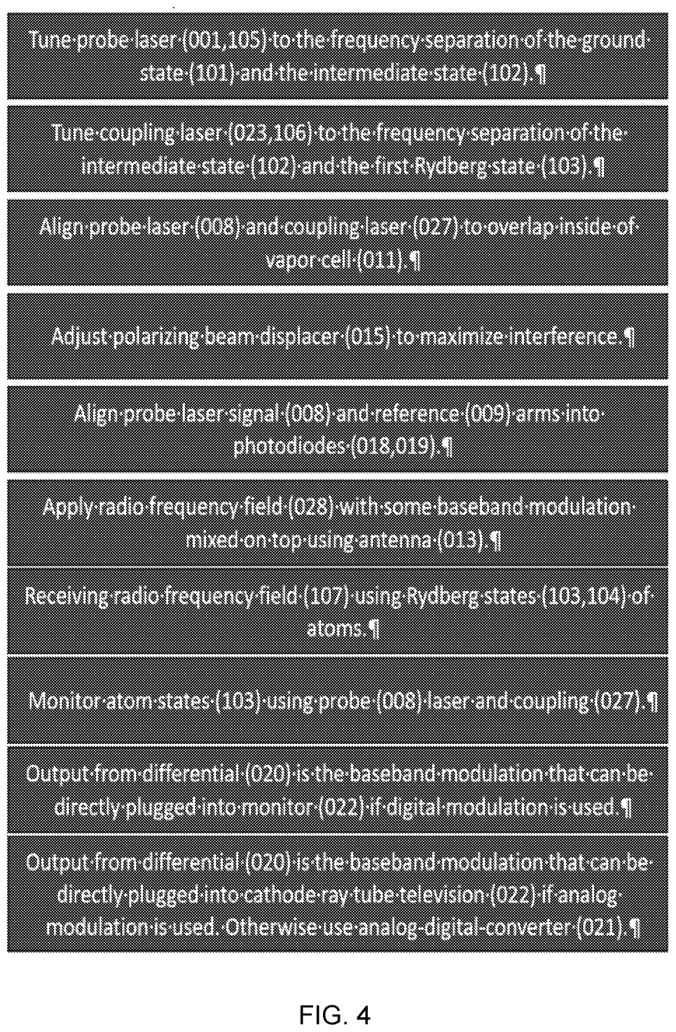

FIG. 5 shows, according to some embodiments, a computer system for providing certain processing of data for Rydberg atom television receiver.

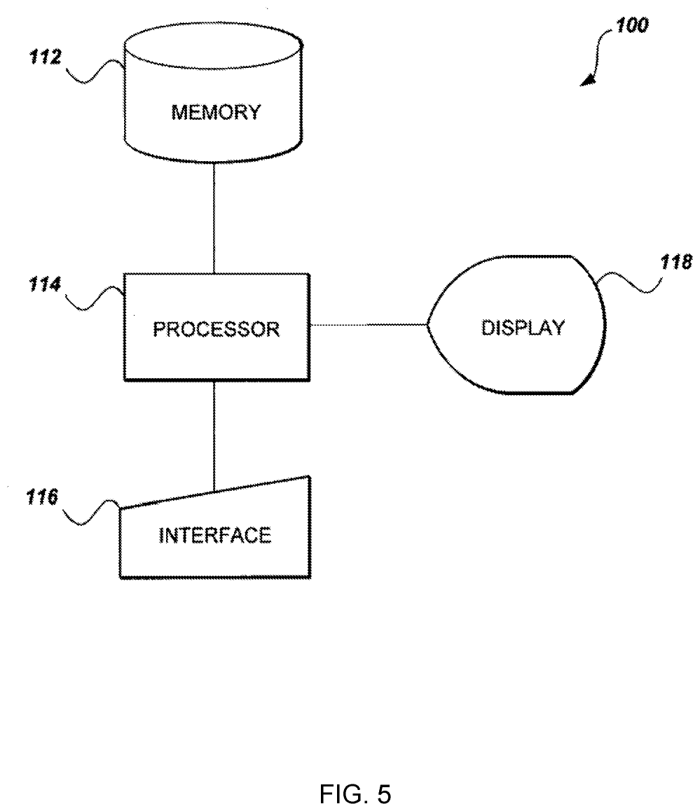

FIG. 6 shows, according to some embodiments, (a) a level diagram depicting EIT coupling the 5S_{1/2} and 50D_{5/2} states through the 5P_{3/2} intermediate state. Radio frequency (RF) field couples the Rydberg states 50D_{5/2} and 51P_{3/2}. (b) Sample EIT resonance (i) without RF carrier, (ii) with RF carrier, and (iii) with RF carrier being modulated. (c) Live data from the camera for a couple rows of data measured by oscilloscope. (Red) Direct signal from camera that is being mixed with RF carrier. (Yellow) Transmission signal from photo-detector that that shows down converted modulation on RF from the camera. (d) Live TV image obtained through output from the photo-detector with no filtering or external amplification (see video file attached for live feed).

FIG. 7 shows, according to some embodiments, probe transmission for a beam size of 85 μm. (a) EIT resonance as the coupling laser is scanned for different probe powers. (b) Square wave is detected when the coupling laser is locked to the EIT peak and the RF source is modulated at 10 kHz (for different probe powers). (c) Zoom in on the fall time of (b). (d) Zoom in on the rise time of (b).

FIG. 8 shows, according to some embodiments, (a) EIT FWHM, (b) EIT amplitude, (c) fall time, and (d) rise time plotted against the probe Rabi frequency (Ωp) (measured at beam waist) for the different beam sizes.

FIG. 9 shows, according to some embodiments, average rise times, fall times, and transit times for the different beam widths. The errors in parentheses are from the standard deviation over the powers.

FIG. 10 shows, according to some embodiments, NTSC 480i video format of a direct output from a video camera to oscilloscope: (a) image of the direct signal to the analog-digital converter, (b) larger time span that captures several frames and their trigger, (c) zoom in on frame that captures three rows and their triggers, and (d) zoom in on row that captures information for each pixel and the color burst that defines the phase. In NTSC 480i, a 3.58 MHz wave carries the pixel saturation in amplitude and color in phase. (e) The fast Fourier transform (FFT) of the transmitted waveform is obtained from two full fields.

FIG. 11 shows, according to some embodiments, (a)-(d) columns of sent and received data from the camera for different beam sizes as labeled. (i) Live video signal from video camera for a given row in NTSC video format. (ii) Signal received by the atoms for the same rows as (i). (iii) The fast Fourier transform (FFT) of the received signal. This is done for two full fields of data acquired. (iv) Video received for the different beam sizes for the given column.

FIG. 12 shows, according to some embodiments, (a) and (b) columns for sent and received data from the game console for different beam sizes as labeled.

### DETAILED DESCRIPTION

A detailed description of one or more embodiments is presented herein by way of exemplification and not limitation.

It has been discovered that Rydberg atoms (highly excited atoms with a single valance electron) probe electromagnetic radiation. By performing spectroscopic measurements of the atoms, Rydberg atom television receiver 200 determines the amplitude and phase of incoming radio frequency field 028. Rydberg atom television receiver 200 can receive and displays a live feed of video with high-quality and at a rate available from various sensors. Data rates can be, e.g., on the order of 200 MBPS achieved by adjusting laser beam size tuning to control transition rates of atoms. Rydberg atom television receiver 200 receives video and data in an arbitrary analog or digital modulation form. and performs digital reception with select hardware. Rydberg atom television receiver 200 includes receiver atoms 012 that receive radio frequency field 028. By probing the atomic resonance of receiver atoms 012, Rydberg atom television receiver 200 can in real time receive broadcasted signals. Rydberg atom television receiver 200 can receive live color video reception using receiver atoms 012. In some embodiments, Rydberg atom television receiver 200 can operate in a modulation bandwidth of 10 MHz, and video schemes use up to 6 MHz modulation with compression methods to obtain high data density. In addition, Rydberg atom television receiver 200 has a large spectral range for a large range of carrier frequencies. Advantageously, Rydberg atom television receiver 200 receives modulated waveforms imprinted on radiofrequency carriers ranging, e.g., from 100 kHz to 100's of GHz.

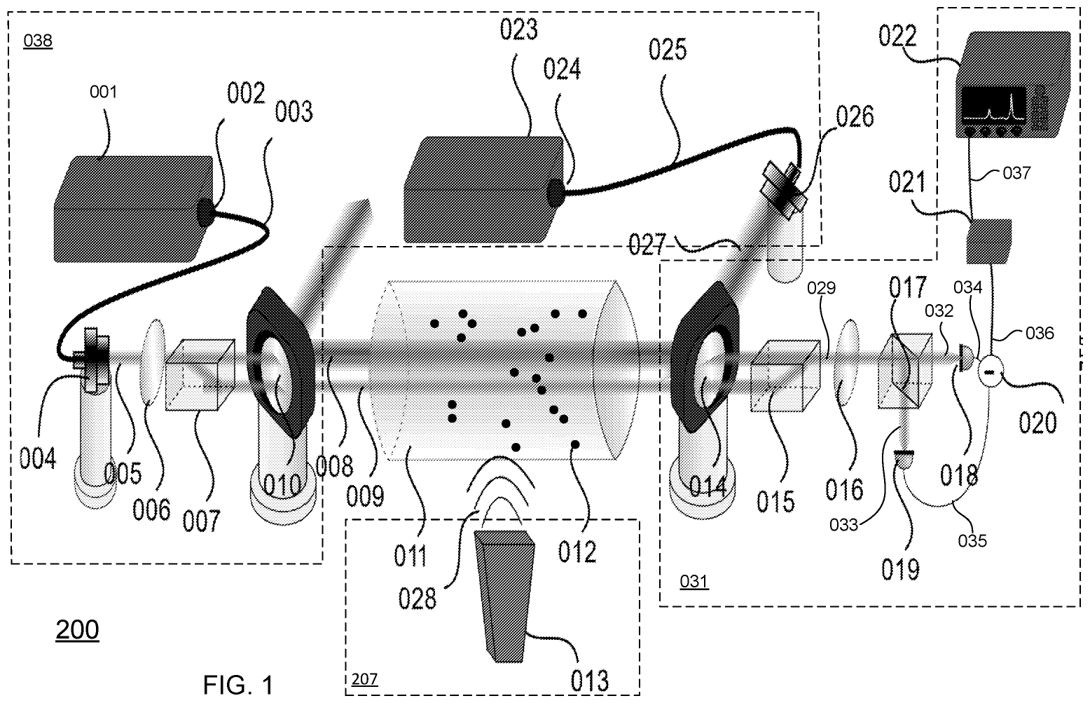

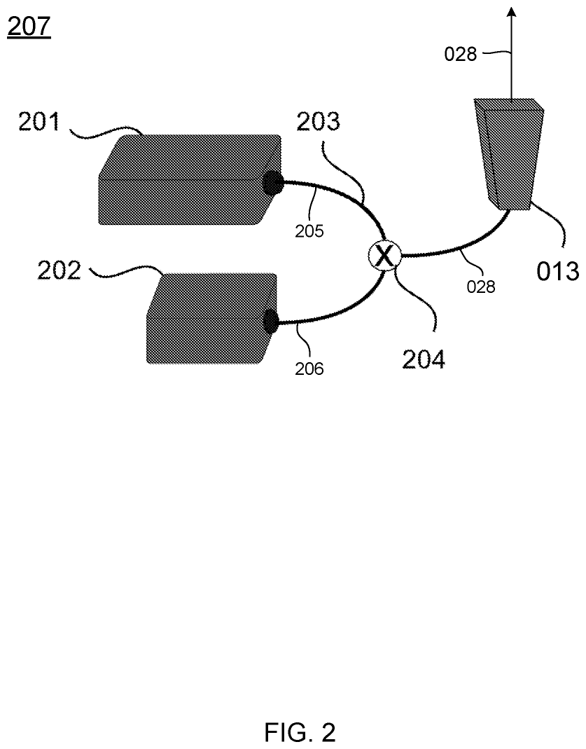

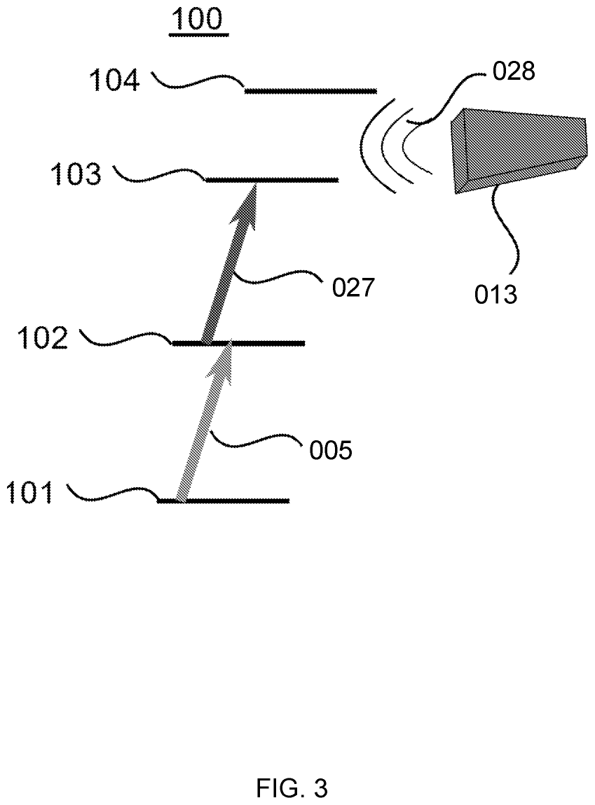

Rydberg atom television receiver 200 receives a modulated waveform imprinted on a radiofrequency carrier. In an embodiment, with reference to FIG. 1, FIG. 2, and FIG. 3, Rydberg atom television receiver 200 for receiving a modulated waveform imprinted on a radiofrequency carrier includes: probe laser 001 in optical communication with Rydberg atom receiver cell 011 and that produces probe laser light 005 and communicates probe laser light 005 to Rydberg atom receiver cell 011; source polarizing beam displacer 007 in optical communication with probe laser 001 and in optical communication with Rydberg atom receiver cell 011 and that receives probe laser light 005 from probe laser 001, optically splits probe laser light 005, produces signal arm laser light 008 and reference arm laser light 009 from optically splitting probe laser light 005, and communicates signal arm laser light 008 and reference arm laser light 009 to Rydberg atom receiver cell 011 signal arm laser light 008 that comprises probe laser light 005 and coupling laser light 027 and that subjects receiver atoms 012 disposed in Rydberg atom receiver cell 011 to probe laser light 005 and coupling laser light 027, such that probe laser light 005 transitions receiver atoms 012 between electronic ground state 101 and intermediate electronic state 102, and coupling laser light 027 transitions receiver atoms 012 between intermediate electronic state 102 and first Rydberg state 103; reference arm laser light 009 that comprises probe laser light 005 and that subjects receiver atoms 012 disposed in Rydberg atom receiver cell 011 to probe laser light 005 in an absence of coupling laser light 027, such that probe laser light 005 transitions receiver atoms 012 between electronic ground state 101 and intermediate electronic state 102; Rydberg atom receiver cell 011 in which is disposed receiver atoms 012 and in optical communication with probe laser 001 and in optical communication with coupling laser 023 and in communication with antenna 013 and that comprises receiver atoms 012 disposed in Rydberg atom receiver cell 011, receives probe laser light 005 and coupling laser light 027 in signal arm laser light 008, receives probe laser light 005 in reference arm laser light 009, receives radio frequency field 028 from antenna 013, subjects receiver atoms 012 to probe laser light 005 along reference arm laser light 009, subjects receiver atoms 012 to probe laser light 005 and coupling laser light 027 along signal arm laser light 008, and subjects receiver atoms 012 to radio frequency field 028 along signal arm laser light 008 and reference arm laser light 009; receiver atoms 012 disposed in Rydberg atom receiver cell 011 and in optical communication with probe fiber optic coupler 002 and in optical communication with coupling laser 023 and in communication with antenna 013 and that receive probe laser light 005 and coupling laser light 027 from signal arm laser light 008, receive probe laser light 005 from reference arm laser light 009, receive radio frequency field 028 from antenna 013, transition between electronic ground state 101 and intermediate electronic state 102 in response to receiving probe laser light 005, transition between first Rydberg state 103 and intermediate electronic state 102 in response to receiving coupling laser light 027, and transition between first Rydberg state 103 and second Rydberg state 104 in response to receiving radio frequency field 028; detector polarizing beam displacer 015 in optical communication with detector dichroic 014 and in optical communication with Rydberg atom receiver cell 011 and that receives probe laser light 005 along signal arm laser light 008 and reference arm laser light 009 after probe laser light 005 communicates through Rydberg atom receiver cell 011, combines and interferes probe laser light 005 from signal arm laser light 008 and reference arm laser light 009, produces Rydberg receiver optical signal 029 from combination and interference of probe laser light 005 in signal arm laser light 008 with probe laser light 005 in reference arm laser light 009, and communicates Rydberg receiver optical signal 029 to detector polarizing beam cube 017; detector polarizing beam cube 017.

In an embodiment, Rydberg atom television receiver 200 includes probe fiber optic coupler 002 disposed on Rydberg atom receiver cell 011 and in mechanical communication with Rydberg atom receiver cell 011 and probe fiber optic cable 003 and that interconnects probe laser 001 and probe fiber optic cable 003 so that probe fiber optic cable 003 receives probe laser light 005 from probe laser 001; probe fiber optic cable 003 disposed on probe fiber optic coupler 002 and in optical communication with probe laser 001 and in mechanical communication with probe fiber optic coupler 002 and that receives probe laser light 005 from probe laser 001 and communicates probe laser light 005 to Rydberg atom receiver cell 011, such that probe fiber optic cable 003 is optically interposed between probe laser 001 and Rydberg atom receiver cell 011; probe fiber optic coupler 004 disposed on probe fiber optic cable 003 and in mechanical communication with probe fiber optic cable 003 and that receives probe fiber optic cable 003 to optically interconnect probe fiber optic cable 003 to Rydberg atom receiver cell 011.

In an embodiment, Rydberg atom television receiver 200 includes source polarization controller 006 in optical communication with probe laser 001 and Rydberg atom receiver cell 011 and that comprises a waveplate and that receives probe laser light 005, communicates probe laser light 005 to Rydberg atom receiver cell 011, and controls optical polarization of probe laser light 005 and optical power of signal arm laser light 008 and reference arm laser light 009.

In an embodiment, Rydberg atom television receiver 200 includes source dichroic mirror 010 in optical communication with source polarizing beam displacer 007 and in optical communication with coupling laser 023 and in optical communication with Rydberg atom receiver cell 011 and that receives signal arm laser light 008 and reference arm laser light 009, communicates probe laser light 005 in signal arm laser light 008 and reference arm laser light 009 to Rydberg atom receiver cell 011, and optically removes coupling laser light 027 from signal arm laser light 008 so that coupling laser light 027 is absent at source polarizing beam displacer 007.

In an embodiment, Rydberg atom television receiver 200 includes antenna 013 in communication with Rydberg atom receiver cell 011 and that communicates radio frequency field 028 to Rydberg atom receiver cell 011

In an embodiment, Rydberg atom television receiver 200 includes detector dichroic 014 in optical communication with detector polarizing beam displacer 015 and in optical communication with coupling laser 023 and in optical communication with Rydberg atom receiver cell 011 and that receives coupling laser light 027 from coupling laser 023, communicates coupling laser light 027 along signal arm laser light 008 to Rydberg atom receiver cell 011, receives probe laser light 005 along signal arm laser light 008 and reference arm laser light 009 from Rydberg atom receiver cell 011, and communicates probe laser light 005 from Rydberg atom receiver cell 011 to detector polarizing beam displacer 015, such that coupling laser light 027 is absent at detector polarizing beam displacer 015.

In an embodiment, Rydberg atom television receiver 200 includes detector polarization controller 016 in optical communication with detector polarizing beam displacer 015 and in optical communication with detector polarizing beam cube 017 and that comprises a waveplate and that receives Rydberg receiver optical signal 029 from detector polarizing beam displacer 015, communicates Rydberg receiver optical signal 029 to detector polarizing beam cube 017, controls optical polarization of Rydberg receiver optical signal 029, mixes Rydberg receiver optical signal 029 produced from signal arm laser light 008 and reference arm laser light 009, and communicates Rydberg receiver optical signal 029 to detector polarizing beam cube 017 for homodyne detection.

In an embodiment, Rydberg atom television receiver 200 includes analog-to-digital converter 021 in electrical communication with differential amplifier 020 and that receives differential signal 036 from display 022 and produces receiver output signal 037 from differential signal 036.

In an embodiment, Rydberg atom television receiver 200 includes: coupling fiber optic coupler 024 disposed on Rydberg atom receiver cell 011 and in mechanical communication with Rydberg atom receiver cell 011 and coupling fiber optic cable 025 and that interconnects coupling laser 023 and coupling fiber optic cable 025 so that coupling fiber optic cable 025 receives coupling laser light 027 from coupling laser 023; coupling fiber optic cable 025 disposed on coupling fiber optic coupler 024 and in optical communication with coupling laser 023 and in mechanical communication with coupling fiber optic coupler 024 and that receives coupling laser light 027 from coupling laser 023 and communicates coupling laser light 027 to Rydberg atom receiver cell 011, such that coupling fiber optic cable 025 is optically interposed between coupling laser 023 and Rydberg atom receiver cell 011; and coupling fiber optic coupler 026 disposed on coupling fiber optic cable 025 and in mechanical communication with coupling fiber optic cable 025 and that receives coupling fiber optic cable 025 to optically interconnect coupling fiber optic cable 025 to Rydberg atom receiver cell 011.

In an embodiment, Rydberg atom television receiver 200 includes: detection unit 031 in optical communication with Rydberg atom receiver cell 011 and that comprises detector dichroic 014 that receives signal arm laser light 008 and reference arm laser light 009 from Rydberg atom receiver cell 011, detector polarizing beam displacer 015 that combines signal arm laser light 008 and reference arm laser light 009 from detector dichroic 014 and produces Rydberg receiver optical signal 029, detector polarization controller 016 that controls optical polarization of Rydberg receiver optical signal 029, detector polarizing beam cube 017 that receives Rydberg receiver optical signal 029 from detector polarization controller 016 and produces first output light 032 and second output light 033 from Rydberg receiver optical signal 029, first photodiode 018 that receives first output light 032 from detector polarizing beam cube 017 and produces first output signal 034 from first output light 032, second photodiode 019 that receives second output light 033 from detector polarizing beam cube 017 and produces second output signal 035 from second output light 033, differential amplifier 020 that receives first output signal 034 from first photodiode 018 and second output signal 035 from second photodiode 019 and produces differential signal 036, analog-to-digital converter 021 that receives differential signal 036 from differential amplifier 020 and produces receiver output signal 037 from differential signal 036, and display 022 that receives receiver output signal 037 from analog-to-digital converter 021 and displays a graphical representation of receiver output signal 037; radiofrequency carrier signal generator 201 in electrical communication with antenna 013 and that produces radiofrequency carrier signal 205 and communicates radiofrequency carrier signal 205 to radiofrequency mixer 204; modulation source 202 in electrical communication with antenna 013 and that produces modulation signal 206 and communicates modulation signal 206 to radiofrequency mixer 204; radiofrequency mixer 204 in electrical communication with radiofrequency carrier signal generator 201 and in electrical communication with modulation source 202 and in electrical communication with antenna 013 and that receives radiofrequency carrier signal 205 from radiofrequency carrier signal generator 201 and modulation signal 206 from modulation source 202, mixes radiofrequency carrier signal 205 and modulation signal 206 such that the baseband modulation frequency of modulation signal 206 is placed on radiofrequency carrier signal 205 to make radio frequency field 028, and communicates radio frequency field 028 to antenna 013.

In an embodiment, Rydberg atom television receiver 200 includes: source unit 038 in optical communication with Rydberg atom receiver cell 011 and that comprises probe laser 001 that produces probe laser light 005, source polarization controller 006 that receives probe laser light 005 from probe laser 001 and controls polarization of probe laser light 005 and communicates probe laser light 005 to source polarizing beam displacer 007, source polarizing beam displacer 007 that receives probe laser light 005 from source polarization controller 006 and splits probe laser light 005 to propagate into signal arm laser light 008 and reference arm laser light 009 and communicates signal arm laser light 008 and reference arm laser light 009 to source dichroic mirror 010, and source dichroic mirror 010 that receives signal arm laser light 008 and reference arm laser light 009 from source polarizing beam displacer 007 and communicates signal arm laser light 008 and reference arm laser light 009 to Rydberg atom receiver cell 011; and radiofrequency cable 203 in electrical communication with radiofrequency carrier signal generator 201 and in electrical communication with modulation source 202 and in electrical communication with radiofrequency mixer 204 and that separately interconnects radiofrequency mixer 204 to radiofrequency carrier signal generator 201 and to modulation source 202, receives radiofrequency carrier signal 205 from radiofrequency carrier signal generator 201 and communicates radiofrequency carrier signal 205 to radiofrequency mixer 204, and receives modulation signal 206 from modulation source 202 and communicates modulation signal 206 to radiofrequency mixer 204.

In an embodiment, Rydberg atom television receiver 200 includes modulated radiofrequency generator 207 in communication with Rydberg atom receiver cell 011 and that includes radiofrequency carrier signal generator 201, modulation source 202, radiofrequency mixer 204, and antenna 013.

Rydberg atom television receiver 200 can be made of various elements and components that can be assembled together or fabricated. Elements of Rydberg atom television receiver 200 can be various sizes and shapes. Elements of Rydberg atom television receiver 200 can be made of a material that is physically or chemically resilient in an environment in which Rydberg atom television receiver 200 is disposed. Exemplary materials include a metal, ceramic, thermoplastic, glass, semiconductor, and the like. The elements of Rydberg atom television receiver 200 can be made of the same or different material and can be monolithic in a single physical body or can be separate members that are physically joined.

Rydberg atom television receiver 200 is a device that receives a modulated waveform imprinted on a radiofrequency carrier and can include probe laser 001, source polarizing beam displacer 007, signal arm laser light 008, reference arm laser light 009, Rydberg atom receiver cell 011, receiver atoms 012, detector polarizing beam displacer 015, detector polarizing beam cube 017, first photodiode 018, second photodiode 019, differential amplifier 020, display 022, and coupling laser 023.

Probe laser 001 can be a pulsed or a continuous-wave (CV) laser that emits probe laser light 005 of a selected wavelength. Probe laser 001 can be a diode laser, but other types of lasers, such as solid-state lasers or gas lasers, can be used. Probe laser 001 is optically coupled to Rydberg atom receiver cell 011 via a fiber optic coupler 002. Probe laser 001 excites receiver atoms 012 in Rydberg atom receiver cell 011. Probe laser light 005 causes receiver atoms 012 to transition between their electronic ground state 101 and intermediate electronic state 102. Intermediate electronic state 102 can be a metastable state, such that receiver atoms 012 remain in this state for a relatively long period of time. This allows receiver atoms 012 to be interrogated by coupling laser light 027 and radio frequency field 028. Probe laser 001 can be operated at a selected power, e.g., of 100 mW or less, suitable for interacting with receiver atoms 012. The wavelength of probe laser light 005 is selected to be resonant with the transition between electronic ground state 101 and intermediate electronic state 102 of receiver atoms 012. Probe laser 001 can be operated in a single-mode configuration.

Coupling laser 023 produces coupling laser light 027 that is used to transition receiver atoms 012 between intermediate electronic state 102 and first Rydberg state 103. Coupling laser 023 can be a pulsed laser or CW laser with a selected pulse width and output power of coupling laser light 027 and wavelength of coupling laser light 027 suitable for interacting with receiver atoms 012. Coupling laser 023 can be, e.g., a diode laser. Coupling laser 023 is optically coupled to Rydberg atom receiver cell 011 so that coupling laser light 027 is directed into Rydberg atom receiver cell 011 to interact with receiver atoms 012. Coupling laser light 027 causes receiver atoms 012 to transition between intermediate electronic state 102 and first Rydberg state 103. This transition is involved with receiver atoms 012 being sensitive to radio frequency field 028.

Optic coupler (probe fiber optic coupler 002, coupling fiber optic coupler 024) is a passive optical component that is used to communicate light. It can be made of a dielectric material, such as glass or plastic, and can have two or more optical fibers that are fused together. There are a variety of different types of probe fiber optic couplers that can be used, such as straight couplers, angled couplers, tapered couplers, fiber grating couplers, and the like.

Fiber optic cable (probe fiber optic cable 003, coupling fiber optic cable 025) can be, e.g., a single-mode, polarization-maintaining fiber optic cable with a core diameter and a cladding. The fiber optic cable can be made of silica glass and can have has a suitable numerical aperture. The fiber optic cable optically communicates probe laser light 005 with a selected wavelength and power. The fiber optic cable can also transmit coupling laser light 027 with a selected wavelength and power that can be the same or different than probe laser light 005. There are various types of probe fiber optic cables, such as single-mode and multi-mode. The fiber optic cable can be made of a suitable optically transparent material, e.g., silica glass. The fiber optic cable can connect on one end to a laser (probe laser 001 or coupling laser 023) and the other end can terminate at probe fiber optic coupler 004 or coupling fiber optic coupler 026 that communicates with a polarization controller (source polarization controller 006) or detector dichroic 014. Laser light is transmitted through the probe fiber optic cable and received by the Rydberg atom receiver cell.

Probe fiber optic coupler 004 can be a passive optical component that couples light from probe laser 001 to Rydberg atom receiver cell 011 or intermediate optics (e.g., source polarization controller 006 or source polarizing beam displacer 007).

Coupling fiber optic coupler 026 can be a passive optical component that couples light from coupling laser 023 to Rydberg atom receiver cell 011 or intermediate optics (e.g., detector dichroic 014).

Probe laser light 005 is a laser beam that excites receiver atoms 012 in Rydberg atom receiver cell 011. Probe laser light 005 can have a selected wavelength (e.g. a visible wavelength) of and power suitable for interacting with receiver atoms 012. Probe laser light 005 excites receiver atoms 012 from electronic ground state 101 to intermediate electronic state 102.

Coupling laser light 027 is a laser beam that optically interacts with receiver atoms 012 in Rydberg atom receiver cell 011. Coupling laser light 027 is produced by coupling laser 023 and is communicated to Rydberg atom receiver cell 011. Coupling laser light 027 can have a selected wavelength, power, pulse width, and repetition rate suitable for interrogating receiver atoms 012. Coupling laser light 027 is transitions receiver atoms 012 between intermediate electronic state 102 and first Rydberg state 103.

Radio frequency field 028 can be a radio frequency electromagnetic field that is applied to receiver atoms 012 disposed in Rydberg atom receiver cell 011. Radio frequency field 028 is used to transition between first Rydberg state 103 and second Rydberg state 104 of receiver atoms 012. Radio frequency field 028 is communicated from antenna 013 to Rydberg atom receiver cell 011.

Source polarization controller 006 controls the polarization of probe laser light 005. It can be made of a birefringent material, such as quartz or calcite. The birefringent material can have two different refractive indices for light polarized in different directions. The user can control the relative intensity of the two output beams by rotating source polarization controller 006. By rotating source polarization controller 006, the user can select the polarization of probe laser light 005 that is sent to Rydberg atom receiver cell 011. Source polarization controller 006 can produce a range of output polarizations, from 0 degrees to 90 degrees. There are a variety of different types of source polarization controllers 006, including a Glan-Thompson prism and a Wollaston prism. To operate source polarization controller 006, select the desired polarization of probe laser light 005 by rotating source polarization controller 006 until the desired polarization has been selected.

Detector polarization controller 016 receives Rydberg receiver optical signal 029 from detector polarizing beam displacer 015, controls polarization of components of Rydberg receiver optical signal 029, and communicates Rydberg receiver optical signal 029 to detector polarizing beam cube 017. Detector polarization controller 016 can be made of a birefringent material, such as quartz or calcite. The birefringent material can have two different refractive indices for light polarized in different directions. The user can control the relative intensity of the two output beams by rotating detector polarization controller 016. By rotating detector polarizing beam displacer 015, the user can select the polarization of Rydberg receiver optical signal 029 that is sent to detector polarizing beam cube 017. Detector polarization controller 016 can produce a range of output polarizations, from 0 degrees to 90 degrees. There are a variety of different types of source polarization controllers 006, including a Glan-Thompson prism and a Wollaston prism. To operate detector polarization controller 016, select the desired polarization of Rydberg receiver optical signal 029 by rotating detector polarization controller 016.

Source polarizing beam displacer 007 is an optical element that is used to split a polarized light beam into two orthogonally polarized beams. It can be made of a birefringent material, such as calcite or quartz that has a different refractive index for light polarized in different directions. When a polarized light beam is incident on source polarizing beam displacer 007, the beam is split into two beams, one of which is polarized parallel to the optic axis of the material and the other of which is polarized perpendicular to the optic axis. The two beams are separated by a distance that can be determined by the thickness of the material and the angle of incidence of the light beam. Source polarizing beam displacer 007 can split a light beam into two beams with a range of output powers. The output power of each beam can be determined by the intensity of the input light beam and the efficiency of source polarizing beam displacer 007. The efficiency of source polarizing beam displacer 007 can be, e.g., from 50% to 90%. There are various types of source polarizing beam displacers, including type I that has a single optic axis, wherein the input light beam is incident on the optic axis of the material, and the two output beams are polarized perpendicular to each other. A type II source polarizing beam displacer 007 has two optic axes, wherein the input light beam is incident on one of the optic axes of the material, and the two output beams are polarized parallel to each other. Source polarizing beam displacer 007 can be made of a birefringent material, such as calcite or quartz. Similarly, detector polarizing beam cube 017 can interfere components of Rydberg receiver optical signal 029 produced from signal arm laser light 008 and reference arm laser light 009 for homodyne detection. Detector polarizing beam cube 017 splitting Rydberg receiver optical signal 029 into two orthogonally polarized components, wherein detector polarizing beam cube 017 produces first output light 032 and second output light 033 from Rydberg receiver optical signal 029 received from detector polarizing beam displacer 015 under polarization-controlled by detector polarization controller 016.

Detector polarizing beam displacer 015 combines and interferes probe laser light 005 from signal arm laser light 008 and reference arm laser light 009, and produces Rydberg receiver optical signal 029 from combination and interference of probe laser light 005 in signal arm laser light 008 with probe laser light 005 in reference arm laser light 009.

Signal arm laser light 008 of Rydberg atom television receiver 200 includes laser light (probe laser light 005, signal arm laser light 008) that is used to excite receiver atoms 012 in Rydberg atom receiver cell 011. Signal arm laser light 008 is produced by output from probe laser 001 that is split into two beams by source polarizing beam displacer 007. One beam is used to excite receiver atoms 012 in reference arm laser light 009, and the other beam is used to excite receiver atoms 012 in signal arm laser light 008. The two beams are then recombined by detector polarizing beam cube 017 and detected by first photodiode 018 and second photodiode 019. The difference between the two signals is then determined by differential amplifier 020 and used to produce receiver output signal 037. Signal arm laser light 008 has a selected wavelength, power, beam diameter, divergence angle, and polarization to interact with receiver atoms 012 in Rydberg atom receiver cell 011.

Reference arm laser light 009 is a laser light that is used to probe the Rydberg atoms in Rydberg atom receiver cell 011. It is derived from probe laser light 005 by source polarizing beam displacer 007. Reference arm laser light 009 has a selected wavelength, power, beam diameter, divergence angle, and polarization to interact with receiver atoms 012 in Rydberg atom receiver cell 011. It should be appreciated that although reference arm laser light 009 includes and can be subjected to radio frequency field 028 from antenna 013, coupling laser light 027 is absent from reference arm laser light 009 so that reference arm laser light 009 includes optical information corresponding to interaction of probe laser light 005 with receiver atoms 012 in an absence of Rydberg states (e.g., first Rydberg state 103 or second Rydberg state 104).

Dichroic mirrors (source dichroic mirror 010, detector dichroic 014) are dielectric mirrors that selectively reflects certain incident light beam and transmits certain other incident light beam. Dichroic mirrors separate probe laser light 005 from coupling laser light 027. Probe laser light 005 is used to excite receiver atoms 012 in Rydberg atom receiver cell 011, and coupling laser light 027 is used to control the transition of receiver atoms 012 between electronic states, namely intermediate electronic state 102 and first Rydberg state 103. Dichroic mirrors can be made of a thin film of dielectric material, such as silicon dioxide or titanium dioxide. The thickness of the dielectric film is chosen such that receiver output signal 037 is reflected by source dichroic mirror 010, while probe laser light 005 is transmitted. Dichroic mirrors can be coated with a layer of anti-reflection coating to reduce the amount of light that is reflected back into probe laser 001. This can improve the efficiency of Rydberg atom television receiver 200. Dichroic mirrors can be used to separate a range of wavelengths of light. There are a variety of different types of source dichroic mirrors 010 that can be used. The type of dichroic mirror that is used can depend on the specific application, e.g., wavelength of coupling laser light 027, based on the energy separation of intermediate electronic state 102 and first Rydberg state 103. Exemplary dichroic mirrors include uniform source dichroic mirrors, bandpass source dichroic mirrors, and edge filter source dichroic mirrors.

Rydberg atom receiver cell 011 can be a cylindrical chamber made of an optically transparent and radiofrequency transparent material, such as glass or quartz. The chamber has a selected length and diameter that is suitable for containing a gas (e.g., an alkali metal) at a selected pressure (e.g., 10⁻⁵ Torr to 10⁻¹⁴ Torr) for interaction of probe laser light 005, coupling laser light 027, and radio frequency field 028. There are a variety of different types of Rydberg atom receiver cells that can be used in a Rydberg atom television receiver. The type of cell that is used will depend on the specific application. Rydberg atom receiver cell 011 can be temperature-stabilized so that an arbitrary pressure or number density of receiver atoms 012 Rydberg atom receiver cell 011 is present in Rydberg atom receiver cell 011.

Receiver atoms 012 receive the modulated waveform imprinted on the radiofrequency carrier and converting it into an optical signal in signal arm laser light 008 and reference arm laser light 009. Receiver atoms 012 can be alkali metal atoms, such as cesium or rubidium. Other types of atoms that have been used include alkaline earth atoms, such as calcium or strontium, and rare earth atoms, such as erbium or ytterbium. These atoms have a large number of electronic energy levels that are accessible at reasonable optical wavelengths. The receiver atoms 012 are excited from electronic ground state 101 by applying a laser pulse of probe laser light 005 that excites receiver atoms 012 to intermediate electronic state 102. The receiver atoms 012 are then subjected to coupling laser light 027 that excites them to first Rydberg state 103. It should be appreciated that first Rydberg state 103 is an excited state that is higher in energy than electronic ground state 101. The physical properties of receiver atoms 012 are determined by the electronic structure of receiver atoms 012 that include the electronic energy levels of the atoms, the transition rates between the levels, and the absorption cross sections of the atoms.

Antenna 013 can be, e.g., a horn antenna that receive a modulated waveform imprinted on a radiofrequency carrier, e.g., radio frequency field 028. Antenna 013 is designed to operate in the radiofrequency range. The specific frequency range of antenna 013 can be determined by the dimensions of a radiating element and ground plane.

Photodiodes (first photodiode 018 and second photodiode 019) detect output light (first output light 032, second output light 033) from detector polarizing beam cube 017 and converts the light to an electrical signal (first output signal 034, second output signal 035), which is then sent to differential amplifier 020. The photodiode can be a semiconductor device that converts light energy into electrical energy. When light strikes the semiconductor material, it creates an electrical current. The amount of current generated can be proportional to the intensity of the light.

Differential amplifier 020 amplifies the difference between two input signals (second output signal 035 and first output signal 034 and produces differential signal 036 from their amplified difference. This is in contrast to a single-ended amplifier, which amplifies only one input signal. Differential amplifier 020 can have a selected gain, which is the ratio of the output voltage to the input voltage, input impedance, output impedance, and bandwidth. Differential amplifier 020 can be, e.g., a single-stage differential amplifier, two-stage differential amplifier, and the like.

Analog-to-digital converter 021 can be a semiconductor integrated circuit (IC) that converts an analog signal to a digital signal, particularly, conversion of differential signal 036 to receiver output signal 037. Analog-to-digital converter 021 can output a digital signal with a range of values and characteristics that are selected based on display 022.

Display 022 of Rydberg atom television receiver 200 can provide a graphical display that shows a graphical representation of receiver output signal 037. Display 022 is electrically connected to analog-to-digital converter 021, which converts receiver output signal 037 to a digital signal. Display 022 then displays the digital signal as a graphical representation. Display 022 can be any suitable type of graphical display, such as a liquid crystal display (LCD), a light-emitting diode (LED) display, or a plasma display. display 022 can be monochrome or color, and it can have any size or resolution. It is contemplated that display 022 can be include a digital signal processor can display images (e.g., live video) or waveforms of electrical signals.

Rydberg receiver optical signal 029 is produced by combining and interfering probe laser light 005 from signal arm laser light 008 and reference arm laser light 009 after probe laser light 005 communicates through Rydberg atom receiver cell 011. Rydberg receiver optical signal 029 is then communicated to detector polarizing beam cube 017 by detector polarization controller 016. The components (first output light 032 and second output light 033) of Rydberg receiver optical signal 029 are detected by photodiodes (019, 018) and converted into an electrical signal that is converted by analog-to-digital converter 021 and displayed on display 022.

Detection unit 031 can include detector polarizing beam displacer 015, detector polarizing beam cube 017, first photodiode 018, second photodiode 019, and differential amplifier 020. detector polarizing beam displacer 015 receives probe laser light 005 along signal arm laser light 008 and reference arm laser light 009 after probe laser light 005 communicates through Rydberg atom receiver cell 011. Detector polarizing beam displacer 015 combines and interferes probe laser light 005 from signal arm laser light 008 and reference arm laser light 009, producing Rydberg receiver optical signal 029. detector polarizing beam cube 017 receives Rydberg receiver optical signal 029 from detector polarizing beam displacer 015 and interferes the components of Rydberg receiver optical signal 029 produced from signal arm laser light 008 and reference arm laser light 009 for homodyne detection. detector polarizing beam cube 017 produces first output light 032 and second output light 033 and communicates first output light 032 to first photodiode 018 and second output light 033 to second photodiode 019. First photodiode 018 converts first output light 032 to first output signal 034 and communicates first output signal 034 to differential amplifier 020. Second photodiode 019 converts second output light 033 to second output signal 035 and communicates second output signal 035 to differential amplifier 020. Differential amplifier 020 receives first output signal 034 from first photodiode 018 and second output signal 035 from second photodiode 019. Differential amplifier 020 determines the difference between first output signal 034 and second output signal 035, producing differential signal 036.

First output light 032 is produced by detector polarizing beam cube 017. It can be a coherent beam of light with a selected wavelength provided, e.g., by probe laser light 005. Second output light 033 is also produced by detector polarizing beam cube 017 and is communicated to second photodiode 019, which converts it to second output signal 035.

First output signal 034 is a photocurrent generated by first photodiode 018 in response to first output light 032. First output signal 034 is a measure of the intensity of first output light 032. Second output signal 035 is a photocurrent generated by second photodiode 019 in response to receiving second output light 033 from detector polarizing beam cube 017. Second output signal 035 is proportional to the intensity of second output light 033.

Differential signal 036 is an electrical signal produced by differential amplifier 020. Differential amplifier 020 receives two input signals, first output signal 034 from first photodiode 018 and second output signal 035 from second photodiode 019. Differential amplifier 020 determines the difference between the two input signals and produces differential signal 036. Differential signal 036 can be used to demodulate the modulated waveform imprinted on the radiofrequency carrier. The modulated waveform is a signal that is used to carry information. The information can be encoded in the phase of the modulated waveform. Differential signal 036 can demodulate the modulated waveform by determining the phase of the modulated waveform.

Receiver output signal 037 is a digital signal that represents, e.g., the modulated waveform imprinted on the radiofrequency carrier. The signal is produced from differential signal 036 from differential amplifier 020, which receives first output signal 034 from first photodiode 018 and second output signal 035 from second photodiode 019. Differential amplifier 020 determines the difference between first output signal 034 and second output signal 035 and produces differential signal 036 from balanced homodyne detection. Analog-to-digital converter 021 then converts differential signal 036 to receiver output signal 037.

Source unit 038 can include probe laser 001 that produces probe laser light 005, source polarization controller 006 that receives probe laser light 005 from probe laser 001 and controls polarization of probe laser light 005 and communicates probe laser light 005 to source polarizing beam displacer 007, source polarizing beam displacer 007 that receives probe laser light 005 from source polarization controller 006 and splits probe laser light 005 to propagate in signal arm laser light 008 and reference arm laser light 009 and communicates signal arm laser light 008 and reference arm laser light 009 to source dichroic mirror 010, and source dichroic mirror 010 that receives signal arm laser light 008 and reference arm laser light 009 from source polarizing beam displacer 007 and communicates signal arm laser light 008 and reference arm laser light 009 to Rydberg atom receiver cell 011.

With reference to FIG. 3, atomic electronic energy level diagram 100 of receiver atoms 012 is a diagram that shows the energy levels as horizontal lines, and the transitions between the energy levels are shown as vertical arrows. Receiver atoms 012 transition between intermediate electronic state 102 and first Rydberg state 103 by coupling laser light 027. The receiver atoms 012 are then subjected to radio frequency field 028. Radio frequency field 028 causes receiver atoms 012 to transition between first Rydberg state 103 and second Rydberg state 104. In this manner, receiver atoms 012 can be monitored for electromagnetic induced transparency (EIT) by detecting signal arm laser light 008 and reference arm laser light 009. Intermediate electronic state 102 can be a state that is located between electronic ground state 101 and first Rydberg state 103 that mediates the interaction between receiver atoms 012 and coupling laser light 027, which allows for the detection of a modulated waveform imprinted on a radiofrequency carrier as applied to receiver atoms 012 by radio frequency field 028.

With reference to FIG. 2, modulated radiofrequency generator 207 is in electromagnetic communication with the Rydberg atom receiver cell 011 and can include radiofrequency carrier signal generator 201, modulation source 202, radiofrequency mixer 204, and antenna 013. Radiofrequency carrier signal generator 201 produces radiofrequency carrier signal 205 and communicates radiofrequency carrier signal 205 to radiofrequency mixer 204. Modulation source 202 generates a modulated waveform that is imprinted on radiofrequency carrier signal 205. Modulation source 202 can be an arbitrary source that generates a modulated waveform. There are a variety of different types of modulation sources such as digital signal generators, analog signal generators, function generators, phase modulators, video cameras, video games, and the like. The type of modulation source that is used will depend on the specific application. Radiofrequency cable 203 can be a coaxial cable that connects antenna 013 to radiofrequency mixer 204 and connects radiofrequency mixer 204 separately to radiofrequency carrier signal generator 201 and modulation source 202. Radiofrequency cable 203 can have an impedance, e.g., of 50 ohms, so that the radiofrequency signal is transmitted efficiently from radiofrequency mixer 204 to antenna 013. Radiofrequency mixer 204 mixing modulation signal 206 with radiofrequency carrier signal 205 to produce radio frequency field 028 that can be amplified or demodulated to produce the original baseband signal. Radiofrequency mixer 204 cab be, e.g., a nonlinear device that produces an output signal that is the sum or difference of input signals. Radiofrequency carrier signal 205 can be, e.g., a sinusoidal signal with a selected radiofrequency with an amplitude suitable for receipt by receiver atoms 012. The radiofrequency can be, e.g., from 100 kHz to hundreds of gigahertz. Modulation signal 206 is a radiofrequency signal that is imprinted on radiofrequency carrier signal 205. Modulation signal 206 is used to carry the information that is to be transmitted.

Rydberg atom television receiver 200 can be made in various ways. It should be appreciated that Rydberg atom television receiver 200 includes a number of optical, electrical, or mechanical components, wherein such components can be interconnected and placed in communication (e.g., optical communication, electrical communication, mechanical communication, and the like) by physical, chemical, optical, or free-space interconnects. The components can be disposed on mounts that can be disposed on a bulkhead for alignment or physical compartmentalization. As a result, Rydberg atom television receiver 200 can be disposed in a terrestrial environment or space environment. Elements of Rydberg atom television receiver 200 can be formed from silicon, silicon nitride, and the like although other suitable materials, such ceramic, glass, or metal can be used. According to an embodiment, the elements of Rydberg atom television receiver 200 are formed using 3D printing although the elements of Rydberg atom television receiver 200 can be formed using other methods, such as injection molding or machining a stock material such as block of material that is subjected to removal of material such as by cutting, laser oblation, and the like. Accordingly, Rydberg atom television receiver 200 can be made by additive or subtractive manufacturing. In an embodiment, elements of Rydberg atom television receiver 200 are selectively etched to remove various different materials using different etchants and photolithographic masks and procedures. The various layers thus formed can be subjected to joining by bonding to form Rydberg atom television receiver 200.

In an embodiment, a process for making Rydberg atom television receiver 200 includes providing probe laser 001 that produces probe laser light 005; providing source polarizing beam displacer 007, wherein source polarizing beam displacer 007 receives probe laser light 005 from probe laser 001, optically splits probe laser light 005, produces signal arm laser light 008 and reference arm laser light 009 from optically splitting probe laser light 005, and communicates signal arm laser light 008 and reference arm laser light 009 to Rydberg atom receiver cell 011; providing Rydberg atom receiver cell 011, wherein Rydberg atom receiver cell 011 includes receiver atoms 012 disposed in Rydberg atom receiver cell 011 and that receives signal arm laser light 008 and coupling laser light 027 in signal arm laser light 008, receives probe laser light 005 in reference arm laser light 009, receives radio frequency field 028 from antenna 013, subjects receiver atoms 012 to probe laser light 005 along reference arm laser light 009, subjects receiver atoms 012 to probe laser light 005 and coupling laser light 027 along signal arm laser light 008, and subjects receiver atoms 012 to radio frequency field 028 along signal arm laser light 008 and reference arm laser light 009; providing detector polarizing beam displacer 015 that receives probe laser light 005 along signal arm laser light 008 and reference arm laser light 009 after probe laser light 005 communicates through Rydberg atom receiver cell 011, combines and interferes probe laser light 005 from signal arm laser light 008 and reference arm laser light 009, produces Rydberg receiver optical signal 029 from the combination and interference of probe laser light 005 in signal arm laser light 008 with probe laser light 005 in reference arm laser light 009, and communicates Rydberg receiver optical signal 029 to detector polarizing beam cube 017; providing detector polarizing beam cube 017 that receives Rydberg receiver optical signal 029 from detector polarizing beam displacer 015, interferes components of Rydberg receiver optical signal 029 produced from signal arm laser light 008 and reference arm laser light 009 for homodyne detection, produces first output light 032 and communicates first output light 032 to first photodiode 018, and produces second output light 033 and communicates second output light 033 to the second photodiode for detecting the other output port of first photodiode 018; providing first photodiode 018 that receives first output light 032 from detector polarizing beam cube 017, converts first output light 032 to first output signal 034, and communicates first output signal 034 to differential amplifier 020; providing a second photodiode that receives second output light 033 from detector polarizing beam cube 017, converts second output light 033 to second output signal 035, and communicates second output signal 035 to differential amplifier 020; and providing differential amplifier 020 that receives first output signal 034 from first photodiode 018, receives second output signal 035 from the second photodiode for detecting the other output port of first photodiode 018, determines the difference between first output signal 034 and second output signal 035, produces a differential signal that is converted to 037 and displayed by display 022.

Rydberg atom television receiver 200 has numerous advantageous and unexpected benefits and uses. In an embodiment, a process for a process for receiving a modulated waveform imprinted on a radiofrequency carrier with Rydberg atom television receiver 200 includes: providing probe laser light 005 to probe laser 001; optically splitting probe laser light 005 into signal arm laser light 008 and reference arm laser light 009; subjecting receiver atoms 012 disposed in Rydberg atom receiver cell 011 to probe laser light 005 and coupling laser light 027, such that probe laser light 005 transitions receiver atoms 012 between electronic ground state 101 and intermediate electronic state 102, and coupling laser light 027 transitions receiver atoms 012 between intermediate electronic state 102 and first Rydberg state 103; receiving radio frequency field 028 from antenna 013; combining and interfering probe laser light 005 from signal arm laser light 008 and reference arm laser light 009; interfering components of Rydberg receiver optical signal 029 produced from signal arm laser light 008 and reference arm laser light 009 for homodyne detection; converting first output light 032 to first output signal 034; converting second output light 033 to second output signal 035; determining the difference between first output signal 034 and second output signal 035; producing differential signal 036 from the difference between first output signal 034 and second output signal 036 for balanced homodyne detection; and displaying a graphical representation of receiver output signal 037.

According to an embodiment, a process for receiving a modulated waveform imprinted on a radiofrequency carrier includes: tuning probe laser 001 to a region of strong absorption of receiver atoms 012; frequency locking probe laser 001 to resonance with an ultra-low expansion cavity and the Pound-Drever hall method with offset locking; providing homodyne detection using polarizing beam displacers (007, 015) and polarizing beam cube 017 for the probe laser to achieve strong signal strengths; tuning coupling laser frequency of coupling laser light 027 to a selected Rydberg state, such that selection of the Rydberg state and atomic species can depend on the radio frequency carrier field 028 that is received (e.g., a radio frequency in a MHz to THz frequency); verifying the correct frequency of the coupling laser (e.g., with a wavemeter); aligning probe laser light 005 in signal arm laser light 008 and coupling laser light 027 in a counter-propagating direction through Rydberg atom receiver cell 011 to be overlapped and the same size; scanning the coupling laser in wavelength; finding electromagnetically induced transparency resonance that maps out the Rydberg state; observing (e.g., on an oscilloscope) output of the differential detection (first photodiode 018, second photodiode 019, differential amplifier 020); locking coupling laser 023 to resonance, e.g., with an ultra-low expansion cavity using Pound-Drever hall method with offset locking; setting radiofrequency carrier signal 205 to the transition frequency between first Rydberg state 103 (to which laser is locked) and second Rydberg state 104; mixing radiofrequency carrier signal 205 with modulation signal 206 (information sent) to produce radio frequency field 028; outputting radio frequency field 028 by antenna 013; and connecting differential amplifier 020 to display 022 (e.g., CRT TV monitor) if receiving analog modulation signals or connecting differential amplifier 020 to analog-to-digital converter 021 and then display 022 (e.g., a digital monitor); and displaying the video feed on display 022.

In an embodiment, TV reception can also be used to receive over-the-air digital TV signals by using a digital TV receiver box by implementing the prior steps for laser setup and further: tuning the coupling laser frequency (023) to a Rydberg state that has the resonance frequency of over the air signals (e.g., from 50 MHz-700 MHz); performing differential detection (018,019,020) and mixing with a 60 MHz carrier using mixer 204; and receiving the output of the mixer to an ATSC converter box and then to a TV monitor.

For tuning probe laser 001 to the resonance of alkali atoms, tuning can occur at a resonance that has a strong absorption signature. For rubidium, the transition between the 5S_{1/2}, F=3 to 5 P_{3/2}, F=4 transition is strong. Tuning can change depending on the atomic species used and which fine structure state is used. Although 5 P_{3/2} can be used, other states can be used to couple to the 5 P_{1/2} state.

Frequency locking can occur using a cavity for enhanced stability offered by the cavity. Locking directly to the atomic resonance through saturation spectroscopy peaks can be used and involves a second cell that the probe laser passes through. The power of the probe laser is on the order of 5 MHz Rabi rate. The size of the beam can be adjusted to increase the speed of the atoms so that color information can be received. It should be appreciated that Rydberg atoms have an intrinsic decay rate that provides a refresh rate, wherein the faster this rate, the faster the sensor is. Smaller beam sizes increase this refresh rate. Additionally, tuning the temperature increases atomic collision rate that also increases the atomic response speed.

Optical homodyne detection provides weak signal enhancement and embodiments provide polarization based mixing and power control that takes advantage of polarizing beam displacers to reduce the number of optical elements and enhances optical stability.

Transition from intermediate state 102 to first Rydberg state 103 is calculated to determine the wavelength for coupling laser 023, which can be a broadly tunable laser that uses second harmonic generation to generate the laser frequency of coupling laser light 027.

The reception of signals via radio frequency field 028 occurs, wherein atoms receive radiofrequency waves ranging from 1 MHz to 1 THz. The signals receive are the baseband so that down conversion electronics are not needed to extract the information included in radio frequency field 028 of modulation signal 206. In an embodiment, a 17 GHz carrier wave carries sound information and video information. The atoms demodulate the 17 GHz carrier wave and output the audio or video information directly to the laser. When a video signal is broadcast, the differential output can be directly connected to a CRT TV. When the signal is output to a digital monitor, use the analog to digital converter.

Rather than receiving a local broadcasted signal, receiver atoms 012 in Rydberg atom receiver cell 011 can pick up over-the-air signals from TV towers. DTV towers broadcast at carrier frequencies of 50 MHz to 700 MHz. Tune the coupling laser frequency to detect these frequencies. The atoms receive the carrier and output the baseband signature. This can be in video compression format as a bit string. In this manner, some of the electronics to down convert can be absent. Optionally, the bitstring can be mixed onto a 50 MHz carrier, and an ATSC receiver can process the waveform.

Various modes of operation of Rydberg atom television receiver 200 include: sending live camera feed in NTSC 780 format on a 17 GHz carrier; sending live game play from a video game console over the same 17 GHz carrier; receiving live digital TV broadcasting over the air; receiving bit string information for communications; and the like.

In an embodiment, Rydberg atom television receiver 200 and receiving a modulated waveform imprinted on a radiofrequency carrier can include the properties, functionality, hardware, and process steps described herein and embodied in any of the following non-exhaustive list:
a process (e.g., a computer-implemented method including various steps; or a method carried out by a computer including various steps);
an apparatus, device, or system (e.g., a data processing apparatus, device, or system including means for carrying out such various steps of the process; a data processing apparatus, device, or system including means for carrying out various steps; a data processing apparatus, device, or system including a processor adapted to or configured to perform such various steps of the process);
a computer program product (e.g., a computer program product including instructions which, when the program is executed by a computer, cause the computer to carry out such various steps of the process; a computer program product including instructions which, when the program is executed by a computer, cause the computer to carry out various steps);
a computer-readable storage medium or data carrier (e.g., a computer-readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product); a computer program product including comprising instructions which, when the program is executed by a first computer, cause the first computer to encode data by performing certain steps and to transmit the encoded data to a second computer; or
a computer program product including instructions which, when the program is executed by a second computer, cause the second computer to receive encoded data from a first computer and decode the received data by performing certain steps.

It should be understood that the calculations may be performed by any suitable computer system, such as that diagrammatically shown in FIG. Data is entered into system 100 via any suitable type of user interface 116, and may be stored in memory 112, which may be any suitable type of computer readable and programmable memory and is preferably a non-transitory, computer readable storage medium. Calculations are performed by processor 114, which may be any suitable type of computer processor and may be displayed to the user on display 118, which may be any suitable type of computer display.

Processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable media include all computer-readable media except for a transitory, propagating signal.

The articles and processes herein are illustrated further by the following Example, which is non-limiting.

### EXAMPLE

TV and Video Game Streaming with a Quantum Receiver

Rydberg states (highly excited) of atoms have been of growing interest in the past decade and have provided an avenue for making a variety of different sensors. This is possible since Rydberg states are highly sensitive to electric fields and, depending on the Rydberg state used, allow for detecting fields ranging from DC to THz. They have been used for the detection of electric fields for amplitude modulation (AM)/FM (and phase modulation) receivers, spectrum analyzers, voltage standards, and angle-of-arrival applications. These sensors even allow for calibrated measurements traceable to the international system of units (SI) for both electrical and radio frequency power.

A current thrust in the development of Rydberg atom-based sensors is geared toward improving the sensitivity and in understanding the limits of bandwidth for these quantum-based receivers. While the reception of various signals has been shown, the reception of live television (TV) has yet to be demonstrated. This limitation largely arises from the bandwidth to signal relationship. We optimize the signal/bandwidth and utilized optical homodyne detection to receive a TV/gaming signal that can be directly output from a photodetector to a TV.

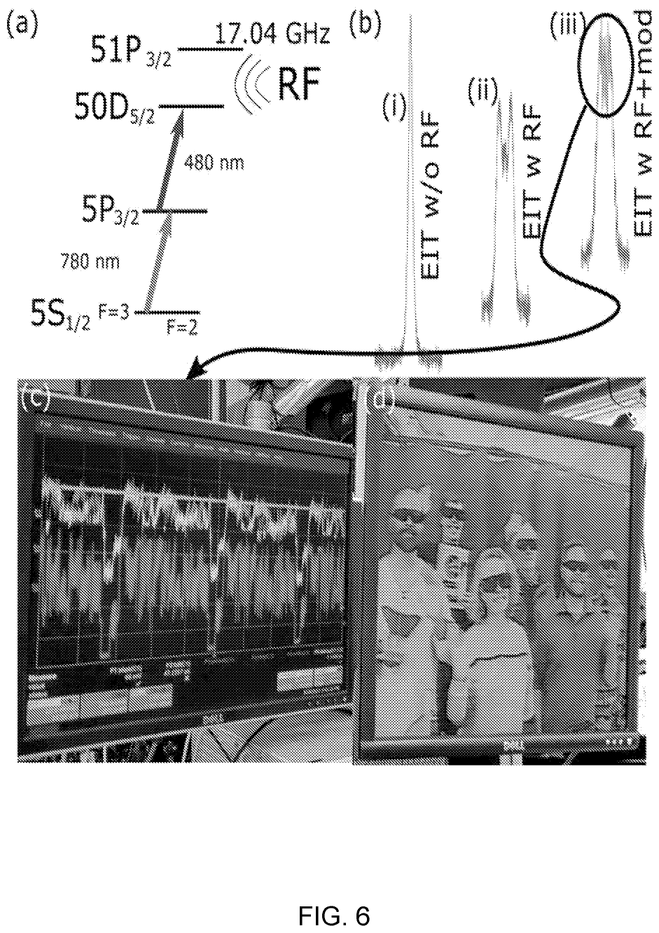

In this setup, we used electromagnetically induced transparency (EIT) to probe the Rydberg state of interest (50D5/2), shown in FIG. 6b and trace in (b) trace (i). Then, we apply a radio frequency (RF) field that is resonant with the 50D5/2→51 P3/2 transition which results in the Autler-Townes (AT) splitting of the Rydberg state, as shown by another trace in FIG. 6b trace (ii). This 17.0434 GHz field is the carrier of our signal. The signal is in the form of analog amplitude modulation of the carrier, as shown in FIG. 6C. Our lasers are locked to an ultra-low expansion cavity using the Pound-Drever-Hall method. We tune the lock to the atomic resonance using an additional modulation to create a tunable offset lock. By locking the laser to the center of the EIT resonance, the energy level shift translates to an amplitude modulation of the transmission signal of the laser, shown in trace (iii) of FIG. 6B. This modulation of the laser is then detected by the photo-detector and can be fed directly to a cathode-ray tube TV. Here, we used an analog to digital converter to transform the analog signal into video graphics array (VGA) format to display on a monitor, shown by FIG. 6D (Multimedia view). This is the demonstration of a quantum receiver being used to watch a live feed from a camera. The underlying light-atom interaction that makes this possible, EIT and AT splitting, require quantum mechanics to be described. While this is closer to so-called “quantum 1.0,” the nature of the receiver allows for the potential to be pushed into the realm of “quantum 2.0” sensors by utilizing quantum enhanced light.

This Example shows how the signal and bandwidth depend on the beam sizes and powers, and how these conditions affect the reception of the live video feed, which ultimately determines the clarity of the reception and if color can be received. FIG. 6D shows a clean reception of a TV signal, with optimal beam size and optical power. In this experiment, we used the setup shown in FIG. 1. This setup allowed us to switch between homodyne detection and balanced differential detection depending on the observed signal.

We use a 780 nm external-cavity diode laser (ECDL) as our probe laser and a 960 nm ECDL amplified by a tapered amplifier that is fed into a second harmonic generation cavity to generate our 480 nm coupling laser. Both lasers' powers at the cell are stabilized at the cell location by using acoustic optic modulators. The coupling laser power is fixed to 70 mW for this study.

The polarizing beam displacer (PBD) splits the 780 nm laser into a signal and reference beam. The signal beam is overlapped with the coupling laser in the vapor cell while the reference beam is not. The vapor cell is a 70 mm quartz cell with windows at the Bragg angle of the probe laser to avoid reflections. The two windows have opposite angles. After interaction in the cell, both signal and reference beams are overlapped spatially using the second PBD. The waveplate slow axis is set to either 0° or 45°. When we want to utilize balanced differential detection, the waveplate is set to balance the signal and reference power and the second waveplate is set to be aligned with the slow axis. For homodyne detection, the first waveplate is set so that the signal beam power is 30 μW and the reference beam is ˜1.5˜1.5 mW. We stabilized the system with boxes to reduce fluctuations from air currents.

We used differential detection when taking power-dependent data for long-term stability and used homodyne detection for added signal strength at lower detector gain. The detector used in these experiments has limited bandwidth at high gain, so we employed homodyne detection to increase the signal such that we could operate the photodetector with lower gain.

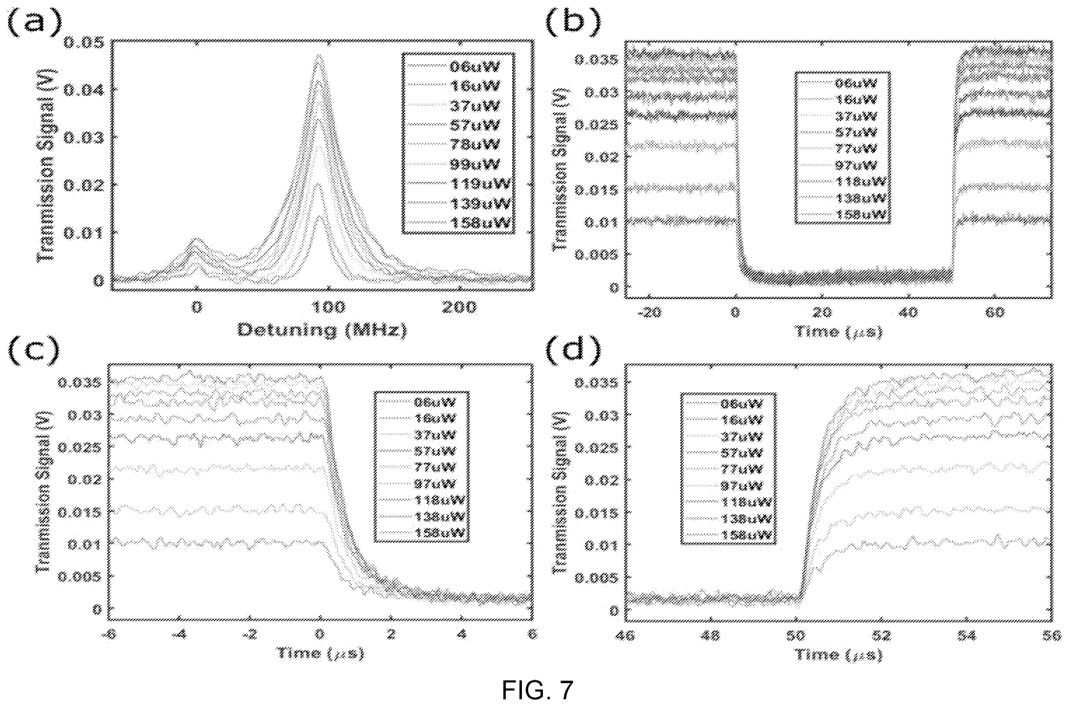

For these experiments, we varied the probe laser beam size and adjusted the coupling laser beam width to keep it slightly larger than the probe. This avoided unwanted effects from spatial intensity variations. The beams were focused at the center of the cell to achieve the desired beam waist. For each beam width, we varied the power of each beam to change the Rabi frequency. FIG. 7A shows the EIT signal as a function of coupling laser detuning for various probe powers. The frequency axis was calibrated using the atomic structure present in the Rydberg states. The stronger EIT peak is the 5P3/2→50D5/2 transition. The weaker peak at the 0 MHz detuning location is from the 5P3/2→50D3/2 transition. The separation of these peaks is 92 MHz. We took these measurements at a beam full-width at half-maximum (FWHM) of 85 μm.

We also measured the rise and fall times of the atomic response by locking both laser frequencies to the EIT resonance and applying a 10 kHz square wave. This was done by locking both the probe and coupling laser to the EIT resonance and observing how the RF field effected the transmission signal. The RF field was generated by a horn antenna with a gain of 17 in our operating frequency range. The horn was placed at 33 cm from the cell location. The 17.0434 GHz RF field was generated by a signal generator and was mixed with a square wave modulation from a function generator using an RF mixer. For the case of the square wave modulation for finding rise and fall times, the RF power fed to the horn was 9.3 dBm that resulted in a field of 1.15 V/m at the location of the atoms. This modulated RF field was then fed to a horn antenna to radiate the atoms, as shown in FIGS. 7(b)-7(d).

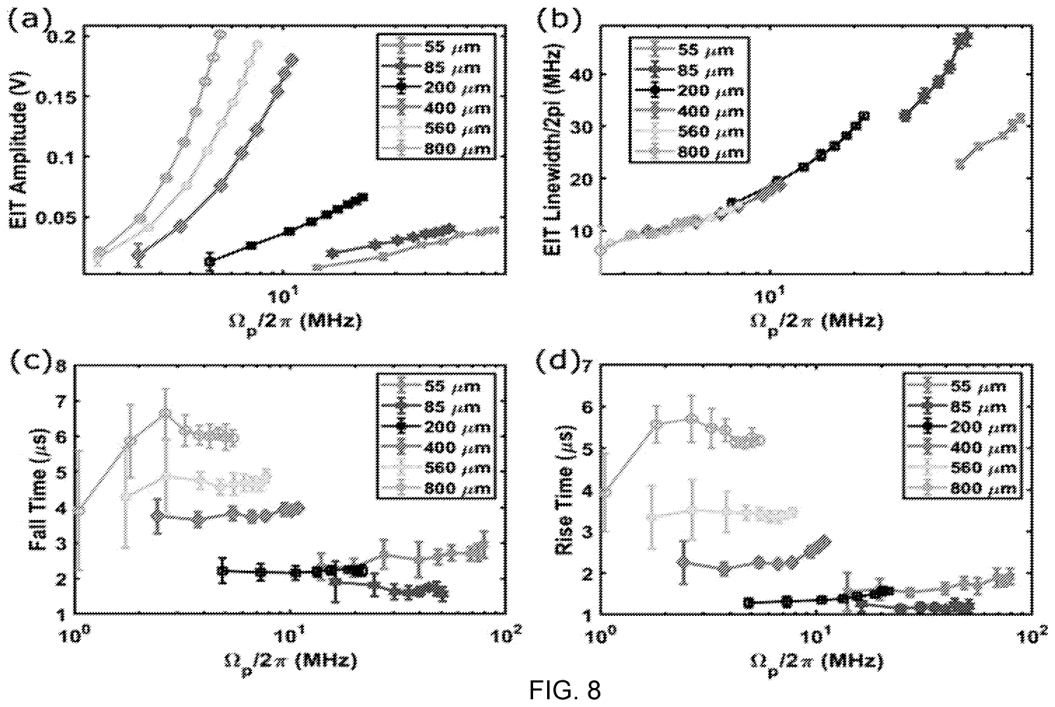

To demonstrate the effects of beam size and powers on the EIT signal and response times, we collect traces, similar to those shown in FIG. 7 for different probe beam powers and beam waists. From these measurements, we extract the EIT height, EIT width, rise times, and fall times, shown by FIG. 8. The extracted values are the average of 10 traces and the error bars are a standard deviation of the 10 measurements. FIG. 8A shows the height of the EIT peak as a function of probe laser Rabi frequency for each beam width. The height of the EIT peak is proportional to the number of atoms that take part in the EIT interaction, which is proportional to the interaction volume. Increasing beam width increases the interaction volume, so for the same Rabi frequency a larger beam results in a stronger EIT peak. FIG. 8B shows the EIT linewidth as a function of the probe Rabi frequency for each beam width. As opposed to the height, the linewidth does not depend on the beam size and is proportional to the Rabi frequency of the probe laser. Note that the measurements for a 55 μm beam width is not in line with the rest of the traces. This is due to the strong divergence of the probe beam used to obtain the tight beam waist at the center of the cell. For this reason, the average beam waist in the cell was 130 μm, nearly a factor of three larger than the actual beam waist. While this was the case for a 55 μm beam waist, the larger beam sizes (22200 μm) used in this paper had an average beam waist that was within 5% of the focused beam waist. For the case of the 85 μm beam waist, the average beam waist was roughly 25% larger. In addition to this, for the case of the 55 μm beam waist, the divergence is not simply defined. While the beam waist is changing, so is the number of atoms in the interaction. This weights the signal such that larger areas would contribute more to the EIT signal.

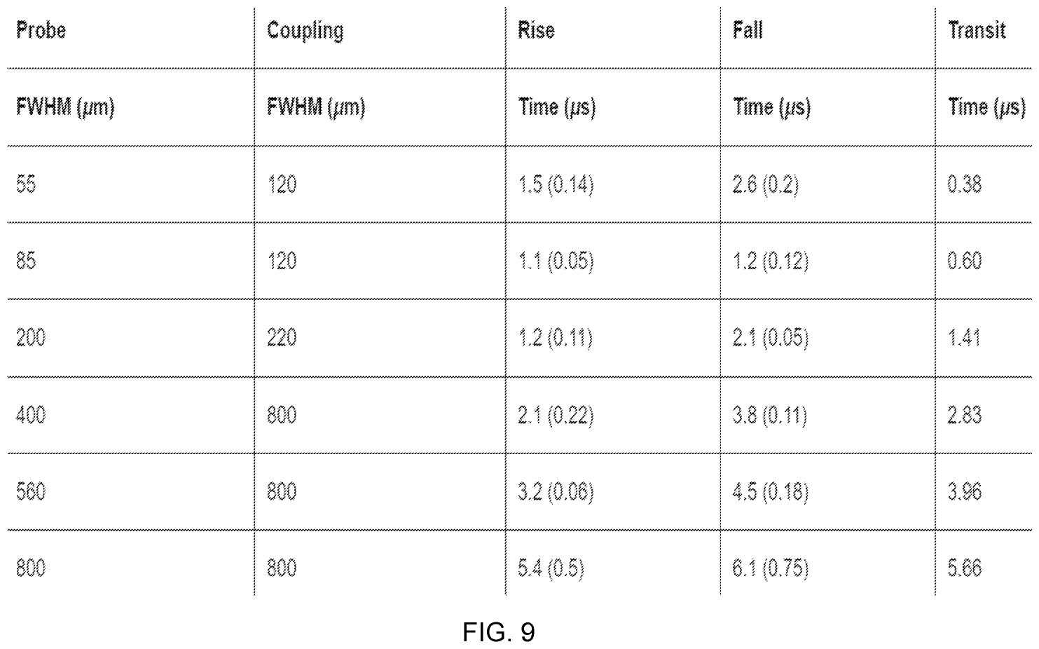

We next investigated the rise and fall times for the atomic response to a square wave as shown in FIG. 8C and FIG. 8D. The fall time is the time or the EIT signal to go from 90% to 10% of the maximum and the rise time is the time for the EIT to signal to go from 10% to 90% of the maximum signal. The temporal response does not significantly depend on the probe Rabi frequency, as opposed to the EIT height. However, both the rise and fall times depend strongly on the beam width. These times are proportional to the beam width, which changes the length of time an atom spends in the interaction volume. Since atoms are moving in and out of the interaction volume, smaller interaction volumes have a larger “refresh rate” for the interaction. The average velocity of room temperature Rubidium atoms is roughly 240 m/s. Hence, an atom will be able to transit through the interaction region within the transit time tₜᵣₐₙₛᵢₜ as given by

$${t}_{transit} = \frac{2 \cdot ω}{ν} , \qquad ( 1 )$$

where ω is the beam waist, and v is the average atomic velocity. We compare the average rise time and fall times to the average transit times for the different beam sizes, as shown in FIG. 9.

We found that the rise and fall times vary with the transit time, except for the 55 μm width. However, this is due to the average beam waist being larger than the average waist for the case of a beam focused to 85 μm. In addition to this, we note that in some cases that the rise time is faster than the transit time. This is due to the rise time being independent of the atomic decay. Establishing a Rydberg population is dependent on the effective Rabi strength of the two-photon interaction.

These results allowed us to optimize the beam size for bandwidth and achieve a sufficiently fast response to stream live video signals from a video camera and from a video game console. For this demonstration, we used an optical homodyne setup, with a signal beam of 30 μW and reference beam of 1.5 mW. The half-waveplate near the photodetector in FIG. 1 rotated the polarization of the signal and reference beams by 45° with respect to the polarizing beam cube slow-axis to mix the reference and signal on the photodetector.

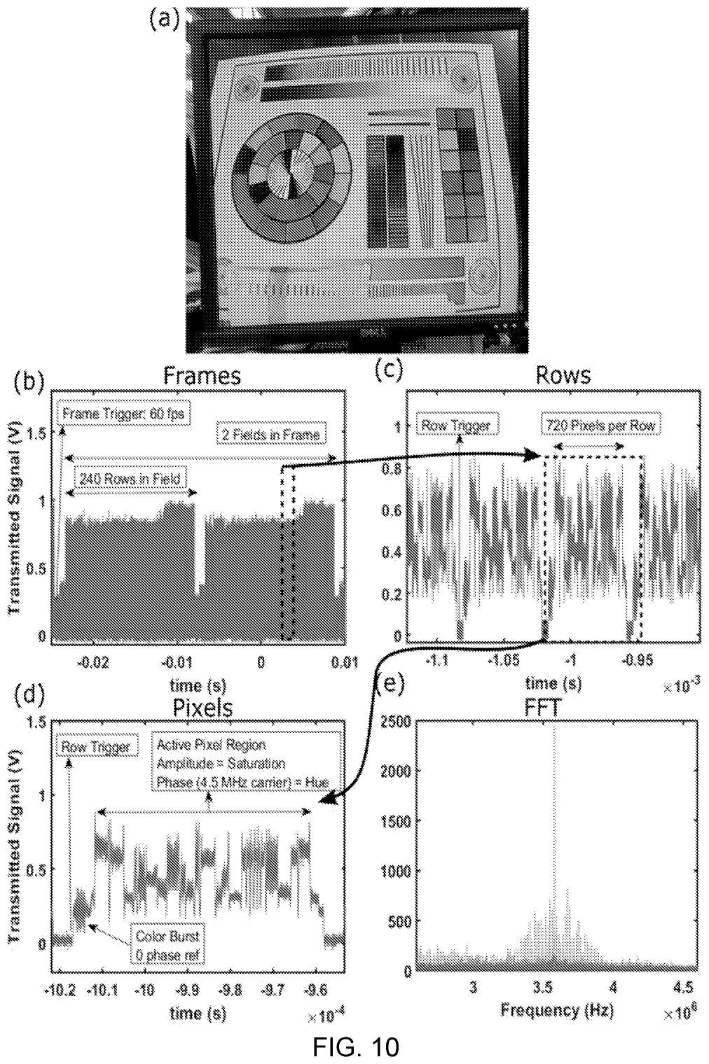

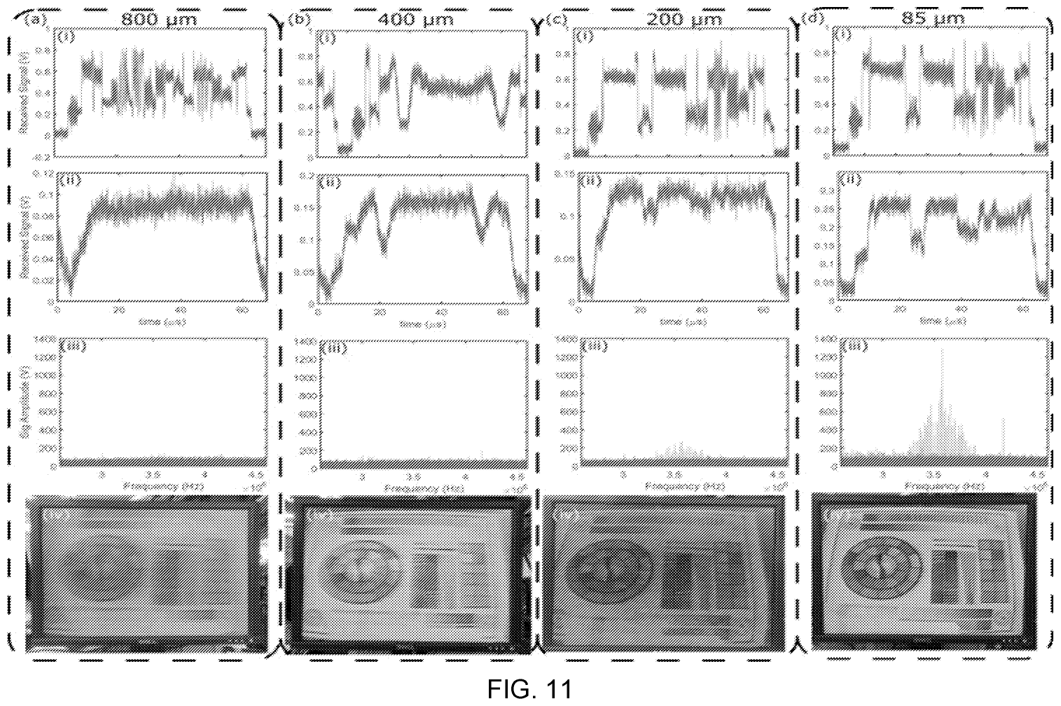

The video format that is output by the camera and the video game console used in this study was National Television Standards Committee 480i, or standard definition. In this example, we streamed the video of a printed color test pattern, shown in FIG. 10A. The direct signal output of the video camera was shown in FIG. 10B-FIG. 10E. The signal is an analog waveform that gives information on the frames, rows, and pixels. FIG. 10B several fields (each is half of an interlaced frame), where we have identified the trigger marker for a given one. We also label the 240 active rows for each field. FIG. 10C shows several rows for a given field and the trigger for each row. FIG. 10D gives the information for each row. After each row trigger, there is a “colorburst” signal that sets the reference phase for the 3.58 MHz carrier that determines the color. Each pixel in the active area of the row is represented by one quarter-cycle of a 3.58 MHz carrier, yielding roughly 720 pixels per row. The amplitude of the cycle gives the saturation of the color, and the phase of the cycle relative to the colorburst gives “chrominance” or hue color information. The color depth for the video camera is nominally 24-bit, with eight bits of information in each of the red, green, and blue basis colors. Brightness or “luminance” is given by the signal offset, making this format backward compatible with black-and-white images when the color information is not present, as seen in FIG. 11. FIG. 10E shows the frequency spectrum of the transmitted signal obtained by performing the FFT on two full fields of transmitted data. The data were normalized so that the differences between the 0 V trigger and voltage offset of the colorburst were the same as those for the received data. This will then allow for a fair comparison of the strength of the 3.6 MHz carrier that determines the fidelity of the signal.

To receive the video signal, both lasers were locked to the EIT resonance. The output from the camera was mixed with a 17.04 GHz carrier using an RF mixer. The strength of the carrier wave feeding the horn antenna was 14.3 dBm. This results in a field strength of 2 V/m at the location of the atoms. The signal from the video camera modulated a 17.04 GHz carrier using an RF mixer. The modulated carrier was fed to a horn antenna to direct the field to the atoms. We compare the original video signal to the down-converted signal on the probe laser received through the atoms in FIG. 11(i) and FIG. 11(ii) for each column (a)-(d). The columns show the measurement results for four different beam sizes, 800, 400, 200, and 85 μm, respectively. Row (iii) in FIG. 11 shows the frequency spectrum of the received signals obtained by performing the FFT. The data were normalized so that the differences between the 0 V trigger and voltage offset of the colorburst were the same for all the beam sizes. The last row (iv) in each column shows the demodulated video displayed on a screen. We see that for the larger beam size (800 μm FWHM), the received signal FIG. 11(a-ii) is distorted compared to the transmitted signal FIG. 11(a-i) due to the slow rise and fall times of the atoms in this configuration. To compare the actual bandwidth received, we look at how the frequency space of the received signals changes near the 3.58 MHz carrier to assess the video quality, shown in FIG. 11(a-iii). The video from the received signal for 800 μm, FIG. 11(a-iv), is very blurry with no color present. Similarly, the 3.6 MHz carrier is not visible in the FFT. For a beam size of 400 μm, we see that the received signal is less distorted, and the received video FIG. 11(b-iv) clearer but lacks color information. The FFT for this beam size does not show the carrier wave, but seems to have some sidebands starting to show. For a beam size of 200 μm, we see that the received signal is less distorted, and the received video FIG. 11(c-iv) is slightly blurry and contains color information. However, there are splotches where the color identification fails. FIG. 11(c-ii) shows the first signs of the 3.6 MHz carrier. However, if we compare the strength of the 3.6 MHz carrier here to that of the transmitted signal, it is nearly an order of magnitude weaker. For a beam size of 85 μm, we see that the received signal is less distorted, and the received video FIG. 11(c=iii) is nearly as sharp as the direct image in FIG. 10A has all the color information with correct saturation. The FFT of the received signal also is nearly as strong as the transmitted signal and only off by less than a factor of 2.

Demodulating the color information requires a higher bandwidth (≈3≈3 MHz) than the black and white intensity information. By optimizing the atomic response times according to FIG. 9 with a probe beam FWHM=85 μm, we were able to achieve video reception that was not only sharp but also captured color information. To determine the data rate that was received, we calculate the effective bit rate of the transmitted signal. The video camera outputs 480i video, interlacing 240 rows (scan lines) of 720 pixels at a field rate of 60 Hz to give a composite 480×720 pixels every 30 Hz. If each pixel carries 24 bits of color information (eight bits for each of red, green, blue) and the nominal bitrate for 480i is 249 Mbps≈60 fields×240 lines field×720 px line×24 color bits px≈60 fields s×240 lines field×720 px line×24 color bits px, not including the information downtime during temporal alignment parts of the signal. Even though our Rydberg response rate and the detector bandwidth both fall well below this rate, we are able to recover enough phase information from the 3.58 MHz color carrier to display 480i color video using an analog-to-digital video converter. However, if we compare the frequency spectrum of the transmitted signal to the received signal for our best video quality, we can see that there is a difference in the strength of the 3.6 MHz carrier wave by roughly a factor of 2. This likely means that we are not retrieving the full information that is transmitted. This is due to the “slew rate” of the atoms that lowers the actual signal change per unit time. To be conservative, we estimate our data rate to be reduced by this factor, for an effective rate of 125 Mbps.

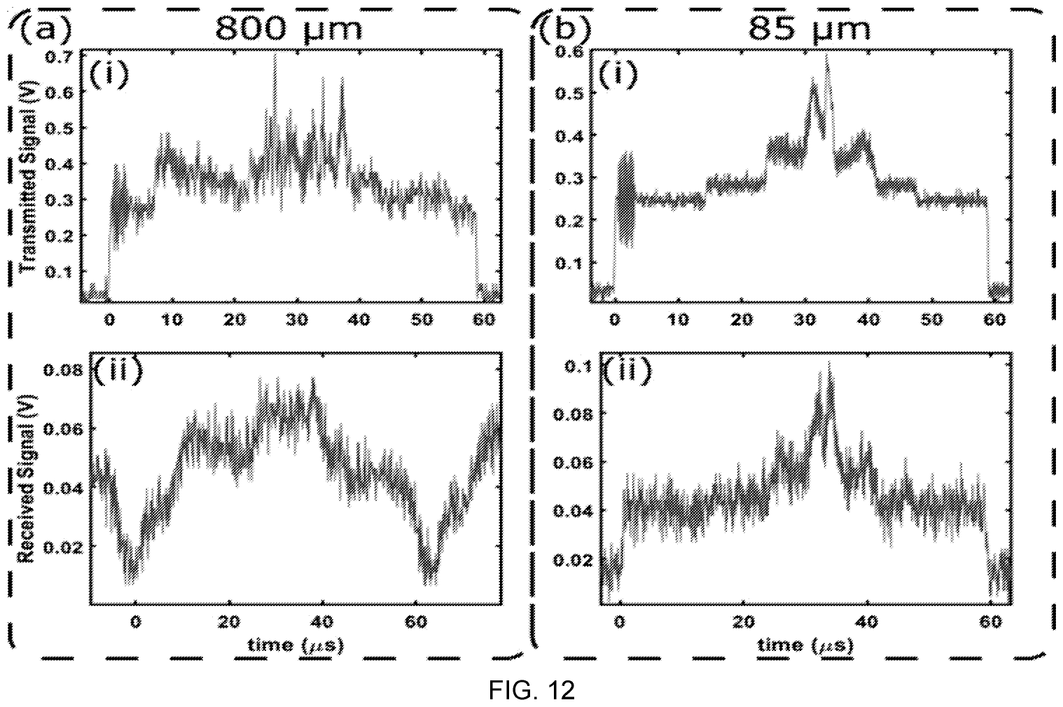

As a final example, we show data from streaming a game console. The video game console also outputs “standard definition” NTSC 480i video. FIG. 12 shows the transmitted FIG. 12(i) received data FIG. 12(ii) from a game console as the game is being played. FIG. 12(a) is for a beam size of 800 μm and this resulted in a blurry image, FIG. 12(b) is for a beam size of 85 μm and the result is a clear color image. The stability of receiving the game signal illustrates the fact that the game could be played in real-time for several hours without losing the signal or its color clarity.

The processes described herein can be embodied in, and fully automated via, software code modules executed by a computing system that includes one or more general purpose computers or processors. The code modules can be stored in any type of non-transitory computer-readable medium or other computer storage device. Some or all the methods may alternatively be embodied in specialized computer hardware. In addition, the components referred to herein can be implemented in hardware, software, firmware, or a combination thereof.

Many other variations than those described herein can be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor can include primarily analog components. For example, some or all of the signal processing algorithms described herein can be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions can be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix (s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It can also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

What is claimed is:

1. A Rydberg atom television receiver for receiving a modulated waveform imprinted on a radiofrequency carrier, the Rydberg atom television receiver comprising:
a probe laser in optical communication with a Rydberg atom receiver cell and that produces a probe laser light and communicates the probe laser light to the Rydberg atom receiver cell;
a source polarizing beam displacer in optical communication with the probe laser and in optical communication with the Rydberg atom receiver cell and that receives the probe laser light from the probe laser, optically splits the probe laser light, produces signal arm laser light and reference arm laser light from optically splitting the probe laser light, and communicates the signal arm laser light and the reference arm laser light to the Rydberg atom receiver cell;
the signal arm laser light that comprises the probe laser light and coupling laser light and that subjects receiver atoms disposed in the Rydberg atom receiver cell to the probe laser light and the coupling laser light, such that the probe laser light transitions the receiver atoms between an electronic ground state and an intermediate electronic state, and the coupling laser light transitions the receiver atoms between the intermediate electronic state and a first Rydberg state;
the reference arm laser light that comprises the probe laser light and that subjects the receiver atoms disposed in the Rydberg atom receiver cell to the probe laser light in an absence of the coupling laser light, such that the probe laser light transitions the receiver atoms between the electronic ground state and the intermediate electronic state;
the Rydberg atom receiver cell in which is disposed the receiver atoms and in optical communication with the probe laser and a coupling laser and in electromagnetic communication with an antenna and that comprises the receiver atoms disposed in the Rydberg atom receiver cell, receives the probe laser light and the coupling laser light in the signal arm laser light, receives the probe laser light in the reference arm laser light, receives a radio frequency field from the antenna, subjects the receiver atoms to the probe laser light along the reference arm laser light, subjects the receiver atoms to the probe laser light and the coupling laser light along the signal arm laser light, and subjects the receiver atoms to the radio frequency field along the signal arm laser light and the reference arm laser light;
the receiver atoms disposed in the Rydberg atom receiver cell and in optical communication with the coupling laser and in electromagnetic communication with the antenna and that receive the probe laser light and the coupling laser light from the signal arm laser light, receive the probe laser light from the reference arm laser light, the receive radio frequency field from the antenna, transition between the electronic ground state and the intermediate electronic state in response to receiving the probe laser light, transition between the first Rydberg state and the intermediate electronic state in response to receiving the coupling laser light, and transition between the first Rydberg state and a second Rydberg state in response to receiving the radio frequency field;
a detector polarizing beam displacer in optical communication with a detector dichroic and in optical communication with the Rydberg atom receiver cell and that receives the probe laser light along the signal arm laser light and the reference arm laser light after the probe laser light communicates through the Rydberg atom receiver cell, combines and interferes the probe laser light from the signal arm laser light and the reference arm laser light, produces a Rydberg receiver optical signal from combination and interference of the probe laser light in the signal arm laser light with the probe laser light in the reference arm laser light, and communicates the Rydberg receiver optical signal to a detector polarizing beam cube;
the detector polarizing beam cube in optical communication with the detector polarizing beam displacer, a first photodiode, and a second photodiode and that receives the Rydberg receiver optical signal from a detector polarization controller, interferes components of the Rydberg receiver optical signal produced from the signal arm laser light and the reference arm laser light for homodyne detection, produces a first output light and communicates the first output light to the first photodiode, and produces a second output light and communicates the second output light to the second photodiode;
the first photodiode in optical communication with the detector polarizing beam cube and in electrical communication with a differential amplifier and that receives the first output light from the detector polarizing beam cube, converts the first output light to a first output signal, and communicates the first output signal to the differential amplifier;
the second photodiode in optical communication with the detector polarizing beam cube and in electrical communication with the differential amplifier and that receives the second output light from the detector polarizing beam cube, converts the second output light to a second output signal, and communicates the second output signal to the differential amplifier;
the differential amplifier in electrical communication with the first photodiode and the second photodiode and that receives the first output signal from first the photodiode, receives the second output signal from the second photodiode, determines the difference between the first output signal and the second output signal, produces a differential signal from the difference between first output signal and the second output signal for balanced homodyne detection;
a display in electrical communication with an analog-to-digital converter and that receives a receiver output signal from the analog-to-digital converter and displays a graphical representation of the receiver output signal; and
the coupling laser in optical communication with the Rydberg atom receiver cell and that produces the coupling laser light and communicates the coupling laser light to the Rydberg atom receiver cell.

2. The Rydberg atom television receiver of claim 1, further comprising a source polarization controller in optical communication with the probe laser and the Rydberg atom receiver cell and that comprises a waveplate and that receives the probe laser light, communicates the probe laser light to the Rydberg atom receiver cell, and controls an optical polarization of the probe laser light and an optical power of the signal arm laser light and the reference arm laser light.

3. The Rydberg atom television receiver of claim 1, further comprising a source dichroic mirror in optical communication with the source polarizing beam displacer, the coupling laser, and the Rydberg atom receiver cell and that receives the signal arm laser light and the reference arm laser light, communicates the probe laser light in the signal arm laser light and the reference arm laser light to the Rydberg atom receiver cell, and optically removes the coupling laser light from the signal arm laser light so that the coupling laser light is absent at the source polarizing beam displacer.

4. The Rydberg atom television receiver of claim 1, further comprising the detector polarization controller in optical communication with the detector polarizing beam displacer and the detector polarizing beam cube and that comprises a waveplate and receives the Rydberg receiver optical signal from the detector polarizing beam displacer, communicates the Rydberg receiver optical signal to the detector polarizing beam cube, controls optical polarization of the Rydberg receiver optical signal, mixes the Rydberg receiver optical signal produced from the signal arm laser light and the reference arm laser light, and communicates the Rydberg receiver optical signal to the detector polarizing beam cube for homodyne detection.

5. The Rydberg atom television receiver of claim 1, further comprising the detector dichroic in optical communication with the detector polarizing beam displacer, the coupling laser, and the Rydberg atom receiver cell and that receives the coupling laser light from the coupling laser, communicates the coupling laser light along the signal arm laser light to the Rydberg atom receiver cell, receives the probe laser light along the signal arm laser light and the reference arm laser light from the Rydberg atom receiver cell, and communicates the probe laser light from the Rydberg atom receiver cell to the detector polarizing beam displacer, such that the coupling laser light is absent at the detector polarizing beam displacer.

6. The Rydberg atom television receiver of claim 1, further comprising the analog-to-digital converter in electrical communication with the differential amplifier and that receives the differential signal from the display and produces the receiver output signal from the differential signal.

7. The Rydberg atom television receiver of claim 1, further comprising:
a coupling fiber optic coupler disposed on the Rydberg atom receiver cell and in mechanical communication with the Rydberg atom receiver cell and the coupling fiber optic cable and that interconnects the coupling laser and a coupling fiber optic cable so that the coupling fiber optic cable receives the coupling laser light from the coupling laser;
the coupling fiber optic cable disposed on the coupling fiber optic coupler and in optical communication with the coupling laser and in mechanical communication with the coupling fiber optic coupler and that receives the coupling laser light from the coupling laser and communicates the coupling laser light to the Rydberg atom receiver cell, such that the coupling fiber optic cable is optically interposed between the coupling laser and the Rydberg atom receiver cell; and
a coupling fiber optic coupler disposed on the coupling fiber optic cable and in mechanical communication with the coupling fiber optic cable and that receives the coupling fiber optic cable to optically interconnect the coupling fiber optic cable to the Rydberg atom receiver cell.

8. The Rydberg atom television receiver of claim 1, further comprising:
a probe fiber optic coupler disposed on the Rydberg atom receiver cell and in mechanical communication with the Rydberg atom receiver cell and in mechanical communication with a probe fiber optic cable and that interconnects the probe laser and the probe fiber optic cable so that the probe fiber optic cable receives the probe laser light from the probe laser;
the probe fiber optic cable disposed on the probe fiber optic coupler and in optical communication with the probe laser and in mechanical communication with the probe fiber optic coupler and that receives the probe laser light from the probe laser and communicates the probe laser light to the Rydberg atom receiver cell, such that the probe fiber optic cable is optically interposed between the probe laser and the Rydberg atom receiver cell; and
a probe fiber optic coupler disposed on the probe fiber optic cable and in mechanical communication with the probe fiber optic cable and that receives the probe fiber optic cable to optically interconnect the probe fiber optic cable to the Rydberg atom receiver cell.

9. The Rydberg atom television receiver of claim 1, further comprising the antenna in communication with the Rydberg atom receiver cell and that communicates the radio frequency field to the Rydberg atom receiver cell.

10. The Rydberg atom television receiver of claim 9, further comprising a modulated radiofrequency generator in electromagnetic communication with the Rydberg atom receiver cell and that comprises a radiofrequency carrier signal generator, a modulation source, a radiofrequency mixer, and the antenna.

11. The Rydberg atom television receiver of claim 10, further comprising:
a detection unit in optical communication with the Rydberg atom receiver cell and that comprises the detector dichroic that receives the signal arm laser light and the reference arm laser light from the Rydberg atom receiver cell, the detector polarizing beam displacer that combines the signal arm laser light and the reference arm laser light from detector dichroic and produces the Rydberg receiver optical signal, the detector polarization controller that controls optical polarization of the Rydberg receiver optical signal, the detector polarizing beam cube that receives the Rydberg receiver optical signal from the detector polarization controller and produces the first output light and the second output light from the Rydberg receiver optical signal, the first photodiode that receives the first output light from the detector polarizing beam cube and produces the first output signal from the first output light, the second photodiode that receives the second output light from the detector polarizing beam cube and produces the second output signal from the second output light, the differential amplifier that receives the first output signal from the first photodiode and the second output signal from the second photodiode and produces the differential signal, the analog-to-digital converter that receives the differential signal from the differential amplifier and produces the receiver output signal from the differential signal, and the display that receives the receiver output signal from the analog-to-digital converter and displays a graphical representation of the receiver output signal;
the radiofrequency carrier signal generator in electrical communication with the antenna and that produces a radiofrequency carrier signal and communicates the radiofrequency carrier signal to the radiofrequency mixer;
the modulation source in electrical communication with the antenna and that produces a modulation signal and communicates the modulation signal to the radiofrequency mixer; and
the radiofrequency mixer in electrical communication with the radiofrequency carrier signal generator and in electrical communication with the modulation source and the antenna and that receives the radiofrequency carrier signal from the radiofrequency carrier signal generator and the modulation signal from the modulation source, mixes the radiofrequency carrier signal and the modulation signal such that the baseband modulation frequency of modulation signal is placed on the radiofrequency carrier signal to make the radio frequency field, and communicates the radio frequency field to the antenna.

12. The Rydberg atom television receiver of claim 11, further comprising:
a source unit in optical communication with the Rydberg atom receiver cell and that comprises the probe laser that produces the probe laser light, the source polarization controller that receives the probe laser light from the probe laser and controls polarization of the probe laser light and communicates the probe laser light to the source polarizing beam displacer, the source polarizing beam displacer that receives the probe laser light from the source polarization controller and splits the probe laser light to propagate in the signal arm laser light and the reference arm laser light and communicates the signal arm laser light and the reference arm laser light to the source dichroic mirror, and the source dichroic mirror that the receives signal arm laser light and the reference arm laser light from the source polarizing beam displacer and communicates the signal arm laser light and the reference arm laser light to the Rydberg atom receiver cell; and
a radiofrequency cable in electrical communication with the radiofrequency carrier signal generator, the modulation source, and the radiofrequency mixer and that separately interconnects the radiofrequency mixer to the radiofrequency carrier signal generator and to the modulation source, receives the radiofrequency carrier signal from the radiofrequency carrier signal generator and communicates the radiofrequency carrier signal to the radiofrequency mixer, and receives the modulation signal from the modulation source and communicates the modulation signal to the radiofrequency mixer.

13. A process for receiving a modulated waveform imprinted on a radiofrequency carrier with a Rydberg atom television receiver, the process comprising:
providing a probe laser light to a Rydberg atom receiver cell;
optically splitting the probe laser light into a signal arm laser light and a reference arm laser light;
subjecting receiver atoms disposed in Rydberg atom receiver cell to the signal arm laser light and coupling laser light, such that the probe laser light transitions receiver atoms between electronic ground state and intermediate electronic state, and the coupling laser light transitions receiver atoms between intermediate electronic state and first Rydberg state;
subjecting receiver atoms disposed in Rydberg atom receiver cell to the reference arm laser light in an absence of coupling laser light, such that the probe laser light transitions receiver atoms between electronic ground state and intermediate electronic state;
subjecting receiver atoms disposed in Rydberg atom receiver cell to a radio frequency field, such that the receiver atoms transition between first Rydberg state and second Rydberg state in response to receiving the radio frequency field;
combining and interfering the probe laser light from the signal arm laser light and the reference arm laser light;
interfering components of the combined and interfered probe laser light produced from the signal arm laser light and the reference arm laser light for homodyne detection;
converting the interfered components of the combined and interfered probe laser light into first output light and second output light;
determining the difference between the first output light and second output light;
producing a differential signal from the difference between the first output light and second output light;
converting the differential signal into a receiver output signal; and
displaying a graphical representation of the receiver output signal.
